(19) United States
(12) Patent Application Publication
(10) Pub. No.: US 2026/0079582 A1
(43) Pub. Date: Mar. 19, 2026

(54) GELATINOUS-STYLE INTERACTIVE VIRTUAL OBJECTS

(71) Applicant: Snap Inc., Santa Monica, CA (US)

(72) Inventors: Yu Lu, Woodland Hills, CA (US); Daria Skrypnyk, Beverly Hills, CA (US); Karen Stolzenberg, Venice, CA (US); Brian Wong, Murrieta, CA (US)

(21) Appl. No.: 18/886,127

(22) Filed: Sep. 16, 2024

(51) Int. Cl. G06F 3/01; G02B 27/01; G06F 3/04817; G06V 40/20

(52) U.S. Cl. CPC G06F 3/017; G02B 27/017; G06F 3/04817; G06V 40/28

(57) ABSTRACT

An XR system using interactive virtual objects having gelatinous attributes is provided. The XR system captures tracking data of a first hand and a second hand of a user. The XR system generates an interactive XR user interface with an interactive virtual object associated with a location on the first hand. The system renders the interactive virtual object using specific attributes and displays it as a component of the interactive XR user interface. The XR system detects a hover event of the user holding a digit of the second hand in proximity to the location on the first hand without touching the location, and in response, renders the interactive virtual object using a second set of attributes and re-displays the interactive virtual object. The XR system applies gelatinous attributes to the interactive virtual object to convey a state of an interactive XR user interface.

### TECHNICAL FIELD

The present disclosure relates generally to user interfaces and, more particularly, to user interfaces used for extended reality.

### BACKGROUND

A head-wearable apparatus can be implemented with a transparent or semi-transparent display through which a user of the head-wearable apparatus can view the surrounding environment. Such head-wearable apparatuses enable a user to see through the transparent or semi-transparent display to view the surrounding environment, and to also see objects (e.g., objects such as a rendering of a 2D or 3D graphic model, images, video, text, and so forth) that are generated for display to appear as a part of, and/or overlaid upon, the surrounding environment. This is typically referred to as “augmented reality” or “AR.” A head-wearable apparatus can additionally completely occlude a user's visual field and display a virtual environment through which a user can move or be moved. This is typically referred to as “virtual reality” or “VR.” In a hybrid form, a view of the surrounding environment is captured using cameras, and then that view is displayed along with augmentation to the user on displays the occlude the user's eyes. As used herein, the term eXtended Reality (XR) refers to augmented reality, virtual reality and any of hybrids of these technologies unless the context indicates otherwise.

A user of the head-wearable apparatus can access and use a computer software application to perform various tasks or engage in an activity. To use the computer software application, the user interacts with a user interface provided by the head-wearable apparatus.

### BRIEF DESCRIPTION OF THE SEVERAL VIEWS OF THE DRAWINGS

In the drawings, which are not necessarily drawn to scale, like numerals can describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A is a perspective view of a head-wearable apparatus, according to some examples.

FIG. 1B illustrates a further view of the head-wearable apparatus of FIG. 1A, according to some examples.

FIG. 2 illustrates a system in which the head-wearable apparatus is operably connected to a mobile device, according to some examples.

FIG. 3 illustrates a networked environment, according to some examples.

FIG. 4 is a block diagram showing a software architecture, according to some examples.

FIG. 5 is a diagrammatic representation of a machine in the form of a computer system, according to some examples.

FIG. 6 illustrates a collaboration diagram of components of an XR system, according to some examples.

FIG. 7A illustrates a palmar surface user interface, according to some examples.

FIG. 7B illustrates an interactive virtual object used with an interactive XR user interface, according to some examples.

FIG. 7C illustrates states of an interactive virtual object during a user interaction, according to some examples.

FIG. 8A illustrates a hand dorsal surface user interface, according to some examples.

FIG. 8B illustrates states of an interactive virtual object of a hand dorsal surface user interface, according to some examples.

FIG. 9 illustrates an interactive virtual object method, according to some examples.

FIG. 10A illustrates a machine-learning pipeline, according to some examples.

FIG. 10B illustrates training and use of a machine-learning program, according to some examples.

### DETAILED DESCRIPTION

The present disclosure addresses several challenges commonly encountered in the realm of extended reality (XR) interfaces. Firstly, traditional XR interfaces often struggle with user engagement due to static and uninviting design elements that fail to capture the user's attention effectively. This lack of engagement can lead to a disconnection between the user and the digital content, reducing the overall effectiveness and enjoyment of the XR experience. Secondly, many existing XR systems do not fully exploit the potential of 3D space, instead relying on flat, two-dimensional interaction models that do not leverage the immersive nature of XR technologies. These issues highlight a need for more dynamic and engaging interface designs that utilize the unique capabilities of XR to enhance user interaction and immersion.

The methodologies described by this disclosure provide solutions to these problems by incorporating interactive virtual objects with visually appealing and responsive design elements. By utilizing materials and colors that mimic real-world tactile experiences, such as a jelly-like gelatinous material and vibrant, translucent colors, the invention significantly enhances user engagement. These design choices not only make the interface elements more inviting but also more visually engaging, encouraging users to interact with the XR system more frequently and with greater enjoyment. The use of 3D interaction models and responsive virtual objects further exploits the spatial capabilities of XR, creating a more immersive and intuitive user experience that aligns with the natural human interaction patterns.

In some examples, the XR system captures, using one or more sensors, tracking data of a first hand and a second hand of a user. While continuing to capture the tracking data, the XR system generates, using the tracking data, an interactive XR user interface including an interactive virtual object associated with a location on the first hand. The XR system renders the interactive virtual object using a first set of attributes and displays the interactive virtual object as a component of the interactive XR user interface. The XR system detects, using the tracking data, a hover event of the user holding a digit of the second hand in proximity to the location on the first hand without touching the location. In response to detecting the hover event, the XR system renders the interactive virtual object using a second set of attributes and re-displays the interactive virtual object as a component of the interactive XR user interface.

In some examples, the XR system detects, using the tracking data, a hand touch event of the user touching the first hand at the location on the first hand with the digit of the second hand and, in response to detecting the hand touch event, the XR system renders the interactive virtual object using a third set of attributes and re-displays the interactive virtual object to the user. The XR system determines a user interface interaction based on the hand touch event at the location.

In some examples, the XR system renders the interactive virtual object as a translucent spheroid.

In some examples, the XR system renders the interactive virtual object as an internally lighted translucent spheroid.

In some examples, the XR system renders the interactive virtual object as a translucent spheroid encircled by a ring.

In some examples, the XR system renders the interactive virtual object as an internally lighted translucent spheroid encircled by a light emitting ring.

In some examples, the XR system renders the interactive virtual object as a translucent spheroid having a dimpled upper surface and encircled by a ring.

In some examples, the XR system renders the interactive virtual object as an internally lighted translucent spheroid having a dimpled upper surface and encircled by a light emitting ring.

In some examples, the XR system includes one or more icons in the interactive virtual object, and the XR system renders and displays the one or more icons oriented to be visible to the user independently of a position of the first hand.

Other technical features can be readily apparent to one skilled in the art from the following figures, descriptions, and claims.

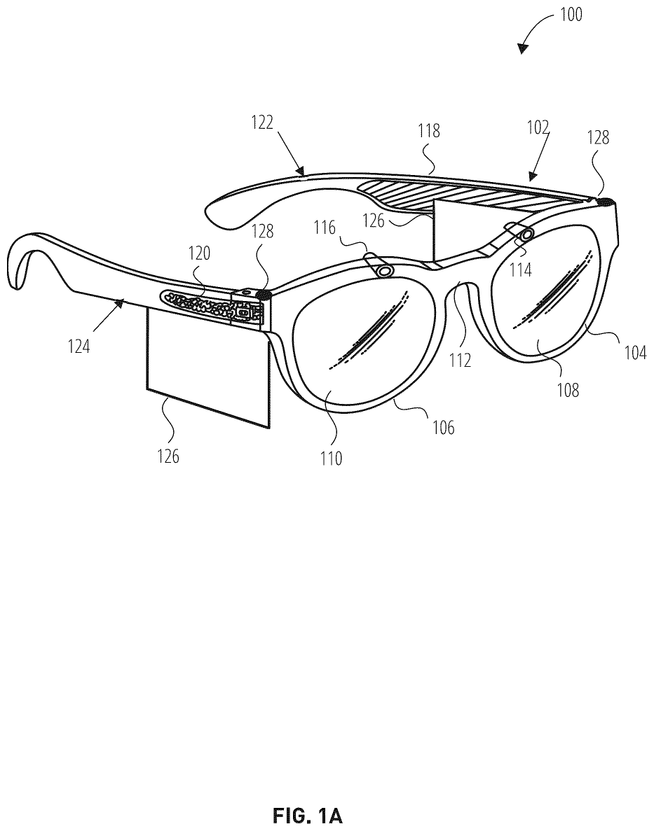

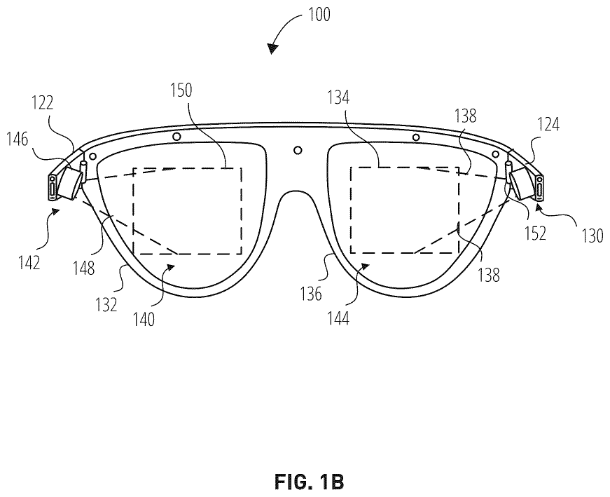

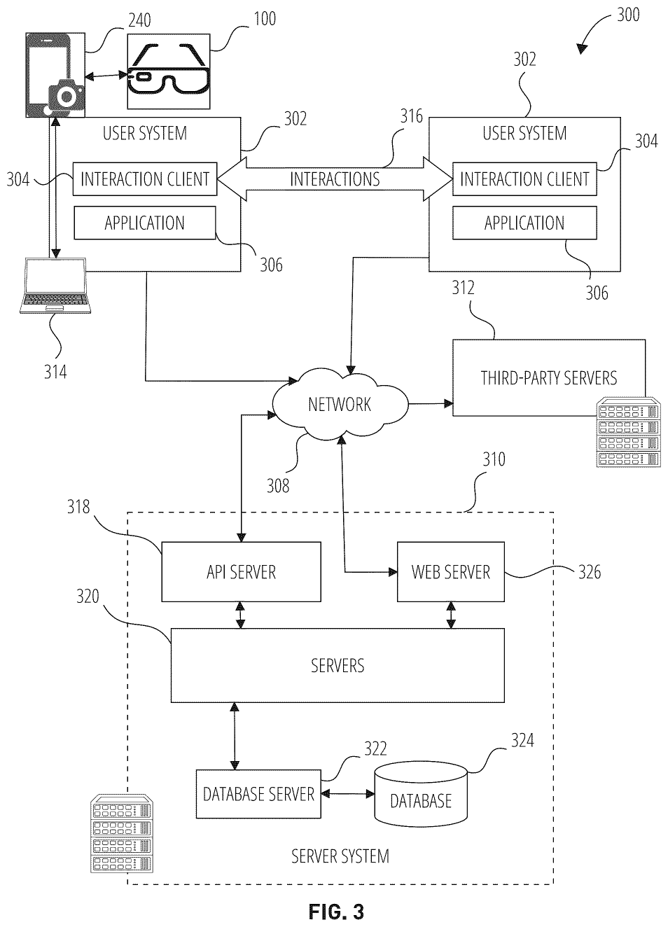

FIG. 1A is a perspective view of a head-wearable apparatus 100 according to some examples. The head-wearable apparatus 100 can be a client device of an XR system, such as a user system 302 of FIG. 3. The head-wearable apparatus 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the head-wearable apparatus 100.

The frame 102 additionally includes a left arm or left temple piece 122 and a right arm or right temple piece 124. In some examples the frame 102 can be formed from a single piece of material so as to have a unitary or integral construction.

The head-wearable apparatus 100 can include a computing device, such as a computer 120, which can be of any suitable type so as to be carried by the frame 102 and, in one or more examples, of a suitable size and shape, so as to be partially disposed in one of the left temple piece 122 or the right temple piece 124. The computer 120 can include one or more processors with memory, wireless communication circuitry, and a power source. As discussed below, the computer 120 comprises low-power circuitry 224, high-speed circuitry 226, and a display processor. Various other examples can include these elements in different configurations or integrated together in different ways. Additional details of aspects of the computer 120 can be implemented as illustrated by the machine 500 discussed herein.

The computer 120 additionally includes a battery 118 or other suitable portable power supply. In some examples, the battery 118 is disposed in left temple piece 122 and is electrically coupled to the computer 120 disposed in the right temple piece 124. The head-wearable apparatus 100 can include a connector or port (not shown) suitable for charging the battery 118, a wireless receiver, transmitter or transceiver (not shown), or a combination of such devices.

The head-wearable apparatus 100 includes a first or left camera 114 and a second or right camera 116. Although two cameras are depicted, other examples contemplate the use of a single or additional (i.e., more than two) cameras.

In some examples, the head-wearable apparatus 100 includes any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide tracking image data for use by the head-wearable apparatus 100 to extract 3D information from a real-world scene.

The head-wearable apparatus 100 can also include a touchpad 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input can be provided by one or more buttons 128, which in the illustrated examples are provided on the outer upper edges of the left optical element holder 104 and right optical element holder 106. The one or more touchpads 126 and buttons 128 provide a means whereby the head-wearable apparatus 100 can receive input from a user of the head-wearable apparatus 100.

FIG. 1B illustrates the head-wearable apparatus 100 from the perspective of a user while wearing the head-wearable apparatus 100. For clarity, a number of the elements shown in FIG. 1A have been omitted. As described in FIG. 1A, the head-wearable apparatus 100 shown in FIG. 1B includes left optical element 140 and right optical element 144 secured within the left optical element holder 132 and the right optical element holder 136 respectively.

The head-wearable apparatus 100 includes right forward optical assembly 130 comprising a left near eye display 150, a right near eye display 134, and a left forward optical assembly 142 including a left projector 146 and a right projector 152.

In some examples, the near eye displays are waveguides. The waveguides include reflective or diffractive structures (e.g., gratings and/or optical elements such as mirrors, lenses, or prisms). Light 138 emitted by the right projector 152 encounters the diffractive structures of the waveguide of the right near eye display 134, which directs the light towards the right eye of a user to provide an image on or in the right optical element 144 that overlays the view of the real-world scene seen by the user. Similarly, light 148 emitted by the left projector 146 encounters the diffractive structures of the waveguide of the left near eye display 150, which directs the light towards the left eye of a user to provide an image on or in the left optical element 140 that overlays the view of the real-world scene seen by the user. The combination of a Graphical Processing Unit, an image display driver, the right forward optical assembly 130, the left forward optical assembly 142, left optical element 140, and the right optical element 144 provide an optical engine of the head-wearable apparatus 100. The head-wearable apparatus 100 uses the optical engine to generate an overlay of the real-world scene view of the user including display of a user interface to the user of the head-wearable apparatus 100.

It will be appreciated however that other display technologies or configurations can be utilized within an optical engine to display an image to a user in the user's field of view. For example, instead of a projector and a waveguide, an LCD, LED or other display panel or surface can be provided.

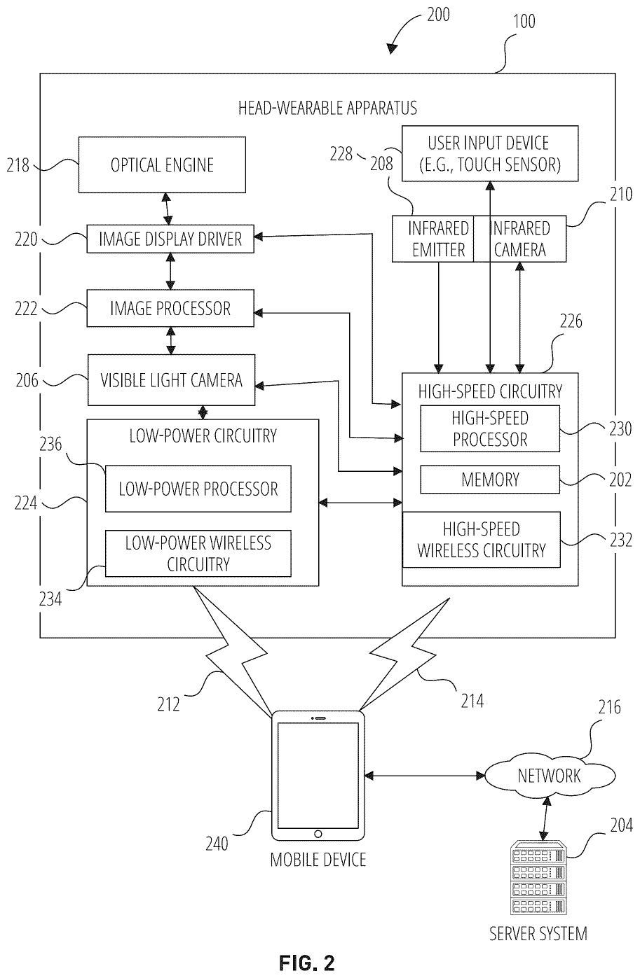

In use, a user of the head-wearable apparatus 100 will be presented with information, content and various user interfaces on the near eye displays. As described in more detail herein, the user can then interact with the head-wearable apparatus 100 using a touchpad 126 and/or the button 128, voice inputs or touch inputs on an associated device (e.g. mobile device 240 illustrated in FIG. 2), and/or hand movements, locations, and positions recognized by the head-wearable apparatus 100.

In some examples, an optical engine of an XR system is incorporated into a lens that is in contact with a user's eye, such as a contact lens or the like. The XR system generates images of an XR experience using the contact lens.

In some examples, the head-wearable apparatus 100 comprises an XR system. In some examples, the head-wearable apparatus 100 is a component of an XR system including additional computational components. In some examples, the head-wearable apparatus 100 is a component in an XR system comprising additional user input systems or devices.

FIG. 2 illustrates a system 200 including a head-wearable apparatus 100 with a selector input device, according to some examples. FIG. 2 is a high-level functional block diagram of an example head-wearable apparatus 100 communicatively coupled to a mobile device 240 and various server systems 204 via various.

The head-wearable apparatus 100 includes one or more cameras, each of which can be, for example, a visible light camera 206, an infrared emitter 208, and an infrared camera 210.

The mobile device 240 connects with head-wearable apparatus 100 using both a low-power wireless connection 212 and a high-speed wireless connection 214. The mobile device 240 is also connected to the server system 204 and the networks 216.

The head-wearable apparatus 100 further includes one or more image displays of the optical engine 218. The optical engines 218 include one associated with the left lateral side and one associated with the right lateral side of the head-wearable apparatus 100. The head-wearable apparatus 100 also includes an image display driver 220, an image processor 222, low-power circuitry 224, and high-speed circuitry 226. The optical engine 218 is for presenting images and videos, including an image that can include a graphical user interface to a user of the head-wearable apparatus 100.

The image display driver 220 commands and controls the optical engine 218. The image display driver 220 can deliver image data directly to the optical engine 218 for presentation or can convert the image data into a signal or data format suitable for delivery to the image display device. For example, the image data can be video data formatted according to compression formats, such as H.264 (MPEG-4 Part 10), HEVC, Theora, Dirac, RealVideo RV40, VP8, VP9, or the like, and still image data can be formatted according to compression formats such as Portable Network Group (PNG), Joint Photographic Experts Group (JPEG), Tagged Image File Format (TIFF) or exchangeable image file format (EXIF) or the like.

The head-wearable apparatus 100 includes a frame and stems (or temples) extending from a lateral side of the frame. The head-wearable apparatus 100 further includes a user input device 228 (e.g., touch sensor or push button), including an input surface on the head-wearable apparatus 100. The user input device 228 (e.g., touch sensor or push button) is to receive from the user an input selection to manipulate the graphical user interface of the presented image.

The components shown in FIG. 2 for the head-wearable apparatus 100 are located on one or more circuit boards, for example a PCB or flexible PCB, in the rims or temples. Alternatively, or additionally, the depicted components can be located in the chunks, frames, hinges, or bridge of the head-wearable apparatus 100. Left and right visible light cameras 206 can include digital camera elements such as a complementary metal oxide- semiconductor (CMOS) image sensor, charge-coupled device, camera lenses, or any other respective visible or light-capturing elements that can be used to capture data, including images of scenes with unknown objects.

The head-wearable apparatus 100 includes a memory 202, which stores instructions to perform a subset, or all the functions described herein. The memory 202 can also include storage device.

As shown in FIG. 2, the high-speed circuitry 226 includes a high-speed processor 230, a memory 202, and high-speed wireless circuitry 232. In some examples, the image display driver 220 is coupled to the high-speed circuitry 226 and operated by the high-speed processor 230 to drive the left and right image displays of the optical engine 218. The high-speed processor 230 can be any processor capable of managing high-speed communications and operation of any general computing system needed for the head-wearable apparatus 100. The high-speed processor 230 includes processing resources needed for managing high-speed data transfers on a high-speed wireless connection 214 to a wireless local area network (WLAN) using the high-speed wireless circuitry 232. In certain examples, the high-speed processor 230 executes an operating system such as a LINUX operating system or other such operating system of the head-wearable apparatus 100, and the operating system is stored in the memory 202 for execution. In addition to any other responsibilities, the high-speed processor 230 executing a software architecture for the head-wearable apparatus 100 is used to manage data transfers with high-speed wireless circuitry 232. In certain examples, the high-speed wireless circuitry 232 is configured to implement Institute of Electrical and Electronic Engineers (IEEE) 802.11 communication standards, also referred to herein as WI-FI®. In some examples, other high-speed communications standards can be implemented by the high-speed wireless circuitry 232.

The low-power wireless circuitry 234 and the high-speed wireless circuitry 232 of the head-wearable apparatus 100 can include short-range transceivers (e.g., Bluetooth™, Bluetooth LE, Zigbee, ANT+) and wireless wide, local, or wide area Network transceivers (e.g., cellular or WI-FI®). Mobile device 240, including the transceivers communicating via the low-power wireless connection 212 and the high-speed wireless connection 214, can be implemented using details of the architecture of the head-wearable apparatus 100, as can other elements of the network 216.

The memory 202 includes any storage device capable of storing various data and applications, including, among other things, camera data generated by the left and right visible light cameras 206, the infrared camera 210, and the image processor 222, as well as images generated for display by the image display driver 220 on the image displays of the optical engine 218. While the memory 202 is shown as integrated with high-speed circuitry 226, in some examples, the memory 202 can be an independent standalone element of the head-wearable apparatus 100. In certain such examples, electrical routing lines can provide a connection through a chip that includes the high-speed processor 230 from the image processor 222 or the low-power processor 236 to the memory 202. In some examples, the high-speed processor 230 can manage addressing of the memory 202 such that the low-power processor 236 will boot the high-speed processor 230 any time that a read or write operation involving memory 202 is needed.

As shown in FIG. 2, the low-power processor 236 or high-speed processor 230 of the head-wearable apparatus 100 can be coupled to the camera (visible light camera 206, infrared emitter 208, or infrared camera 210), the image display driver 220, the user input device 228 (e.g., touch sensor or push button), and the memory 202.

The head-wearable apparatus 100 is connected to a host computer. For example, the head-wearable apparatus 100 is paired with the mobile device 240 via the high-speed wireless connection 214 or connected to the server system 204 via the network 216. The server system 204 can be one or more computing devices as part of a service or network computing system, for example, that includes a processor, a memory, and network communication interface to communicate over the network 216 with the mobile device 240 and the head-wearable apparatus 100.

The mobile device 240 includes a processor and a Network communication interface coupled to the processor. The Network communication interface allows for communication over the network 216, low-power wireless connection 212, or high-speed wireless connection 214. The mobile device 240 can further store at least portions of the instructions in the memory of the mobile device 240 memory to implement the functionality described herein.

Output components of the mobile device 240 include visual components, such as a display such as a liquid crystal display (LCD), a plasma display panel (PDP), a light-emitting diode (LED) display, a projector, or a waveguide. The image displays of the optical assembly are driven by the image display driver 220. The output components of the mobile device 240 further include acoustic components (e.g., speakers), haptic components (e.g., a vibratory motor), other signal generators, and so forth. The input components of the mobile device 240, the mobile device 240, and server system 204, such as the user input device 228, can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 100 can also include additional peripheral device elements. Such peripheral device elements can include sensors and display elements integrated with the head-wearable apparatus 100. For example, peripheral device elements can include any I/O components including output components, motion components, position components, or any other such elements described herein.

In some examples, the head-wearable apparatus 100 can include biometric components or sensors to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data can be used for very limited purposes, such as identification verification. To ensure limited and authorized use of biometric information and other personally identifiable information (PII), access to this data is restricted to authorized personnel only, if at all. Any use of biometric data can strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude can be derived), orientation sensor components (e.g., magnetometers), and the like. Such positioning system coordinates can also be received over low-power wireless connections 212 and high-speed wireless connection 214 from the mobile device 240 via the low-power wireless circuitry 234 or high-speed wireless circuitry 232.

FIG. 3 is a block diagram showing an example digital interaction system 300 for facilitating interactions and engagements (e.g., exchanging text messages, conducting text audio and video calls, or playing games) over a network. The digital interaction system 300 includes multiple user systems 302, each of which hosts multiple applications, including an interaction client 304 and other applications 306. Each interaction client 304 is communicatively coupled, via one or more networks including a network 308 (e.g., the Internet), to other instances of the interaction client 304 (e.g., hosted on respective other user systems), a server system 310 and third-party servers 312). An interaction client 304 can also communicate with locally hosted applications 306 using Applications Program Interfaces (APIs).

Each user system 302 can include multiple user devices, such as a mobile device 240, head-wearable apparatus 100, and a computer client device 314 that are communicatively connected to exchange data and messages.

An interaction client 304 interacts with other interaction clients 304 and with the server system 310 via the network 308. The data exchanged between the interaction clients 304 (e.g., interactions 316) and between the interaction clients 304 and the server system 310 includes functions (e.g., commands to invoke functions) and payload data (e.g., text, audio, video, or other multimedia data).

The server system 310 provides server-side functionality via the network 308 to the interaction clients 304. While certain functions of the digital interaction system 300 are described herein as being performed by either an interaction client 304 or by the server system 310, the location of certain functionality either within the interaction client 304 or the server system 310 can be a design choice. For example, it can be technically preferable to initially deploy particular technology and functionality within the server system 310 but to later migrate this technology and functionality to the interaction client 304 where a user system 302 has sufficient processing capacity.

The server system 310 supports various services and operations that are provided to the interaction clients 304. Such operations include transmitting data to, receiving data from, and processing data generated by the interaction clients 304. This data can include message content, client device information, geolocation information, digital effects (e.g., media augmentation and overlays), message content persistence conditions, entity relationship information, and live event information. Data exchanges within the digital interaction system 300 are invoked and controlled through functions available via user interfaces (UIs) of the interaction clients 304.

Turning now specifically to the server system 310, an Application Program Interface (API) server 318 is coupled to and provides programmatic interfaces to servers 320, making the functions of the servers 320 accessible to interaction clients 304, other applications 306 and third-party server 312. The servers 320 are communicatively coupled to a database server 322, facilitating access to a database 324 that stores data associated with interactions processed by the servers 320. Similarly, a web server 326 is coupled to the servers 320 and provides web-based interfaces to the servers 320. To this end, the web server 326 processes incoming network requests over the Hypertext Transfer Protocol (HTTP) and several other related protocols.

The Application Program Interface (API) server 318 receives and transmits interaction data (e.g., commands and message payloads) between the servers 320 and the user systems 302 (and, for example, interaction clients 304 and other application 306) and the third-party server 312. Specifically, the Application Program Interface (API) server 318 provides a set of interfaces (e.g., routines and protocols) that can be called or queried by the interaction client 304 and other applications 306 to invoke functionality of the servers 320. The Application Program Interface (API) server 318 exposes various functions supported by the servers 320, including account registration; login functionality; the sending of interaction data, via the servers 320, from a particular interaction client 304 to another interaction client 304; the communication of media files (e.g., images or video) from an interaction client 304 to the servers 320; the settings of a collection of media data (e.g., a narrative); the retrieval of a list of friends of a user of a user system 302; the retrieval of messages and content; the addition and deletion of entities (e.g., friends) to an entity relationship graph; the location of friends within an entity relationship graph; and opening an application event (e.g., relating to the interaction client 304).

The interaction client 304 provides a user interface that allows users to access features and functions of an external resource, such as a linked application 306, an applet, or a microservice. This external resource can be provided by a third party or by the creator of the interaction client 304.

The external resource can be a full-scale application installed on the user's system 302, or a smaller, lightweight version of the application, such as an applet or a microservice, hosted either on the user's system or remotely, such as on third-party servers 312 or in the cloud. These smaller versions, which include a subset of the full application's features, can be implemented using a markup-language document and can also incorporate a scripting language and a style sheet.

When a user selects an option to launch or access the external resource, the interaction client 304 determines whether the resource is web-based or a locally installed application. Locally installed applications can be launched independently of the interaction client 304, while applets and microservices can be launched or accessed via the interaction client 304.

If the external resource is a locally installed application, the interaction client 304 instructs the user's system to launch the resource by executing locally stored code. If the resource is web-based, the interaction client 304 communicates with third-party servers to obtain a markup-language document corresponding to the selected resource, which it then processes to present the resource within its user interface.

The interaction client 304 can also notify users of activity in one or more external resources. For instance, it can provide notifications relating to the use of an external resource by one or more members of a user group. Users can be invited to join an active external resource or to launch a recently used but currently inactive resource.

The interaction client 304 can present a list of available external resources to a user, allowing them to launch or access a given resource. This list can be presented in a context-sensitive menu, with icons representing different applications, applets, or microservices varying based on how the menu is launched by the user.

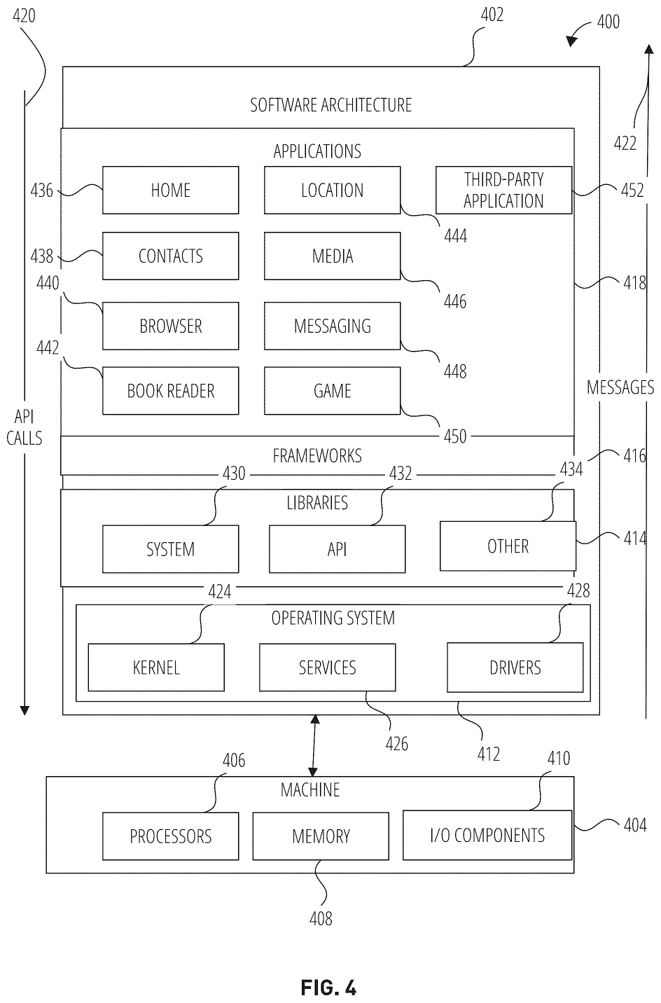

FIG. 4 is a block diagram 400 illustrating a software architecture 402, which can be installed on any one or more of the devices described herein. The software architecture 402 is supported by hardware such as a machine 404 that includes processors 406, memory 408, and I/O components 410. In this example, the software architecture 402 can be conceptualized as a stack of layers, where each layer provides a particular functionality. The software architecture 402 includes layers such as an operating system 412, libraries 414, frameworks 416, and applications 418. Operationally, the applications 418 invoke API calls 420 through the software stack and receive messages 422 in response to the API calls 420.

The operating system 412 manages hardware resources and provides common services. The operating system 412 includes, for example, a kernel 424, services 426, and drivers 428. The kernel 424 acts as an abstraction layer between the hardware and the other software layers. For example, the kernel 424 provides memory management, processor management (e.g., scheduling), component management, networking, and security settings, among other functionalities. The services 426 can provide other common services for the other software layers. The drivers 428 are responsible for controlling or interfacing with the underlying hardware. For instance, the drivers 428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 414 provide a common low-level infrastructure used by the applications 418. The libraries 414 can include system libraries 430 (e.g., C standard library) that provide functions such as memory allocation functions, string manipulation functions, mathematical functions, and the like. In addition, the libraries 414 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 414 can also include a wide variety of other libraries 434 to provide many other APIs to the applications 418.

The frameworks 416 provide a common high-level infrastructure that is used by the applications 418. For example, the frameworks 416 provide various graphical user interface (GUI) functions, high-level resource management, and high-level location services. The frameworks 416 can provide a broad spectrum of other APIs that can be used by the applications 418, some of which can be specific to a particular operating system or platform.

In an example, the applications 418 can include a home application 436, a contacts application 438, a browser application 440, a book reader application 442, a location application 444, a media application 446, a messaging application 448, a game application 450, and a broad assortment of other applications such as a third-party application 452. The applications 418 are programs that execute functions defined in the programs. Various programming languages can be employed to create one or more of the applications 418, structured in a variety of manners, such as object-oriented programming languages (e.g., Objective-C, Java, or C++) or procedural programming languages (e.g., C or assembly language). In a specific example, the third-party application 452 (e.g., an application developed using the ANDROID™ or IOS™ software development kit (SDK) by an entity other than the vendor of a platform) can be mobile software running on a mobile operating system such as IOS™, ANDROID™, WINDOWS® Phone, or another mobile operating system. In this example, the third-party application 452 can invoke the API calls 420 provided by the operating system 412 to facilitate functionalities described herein.

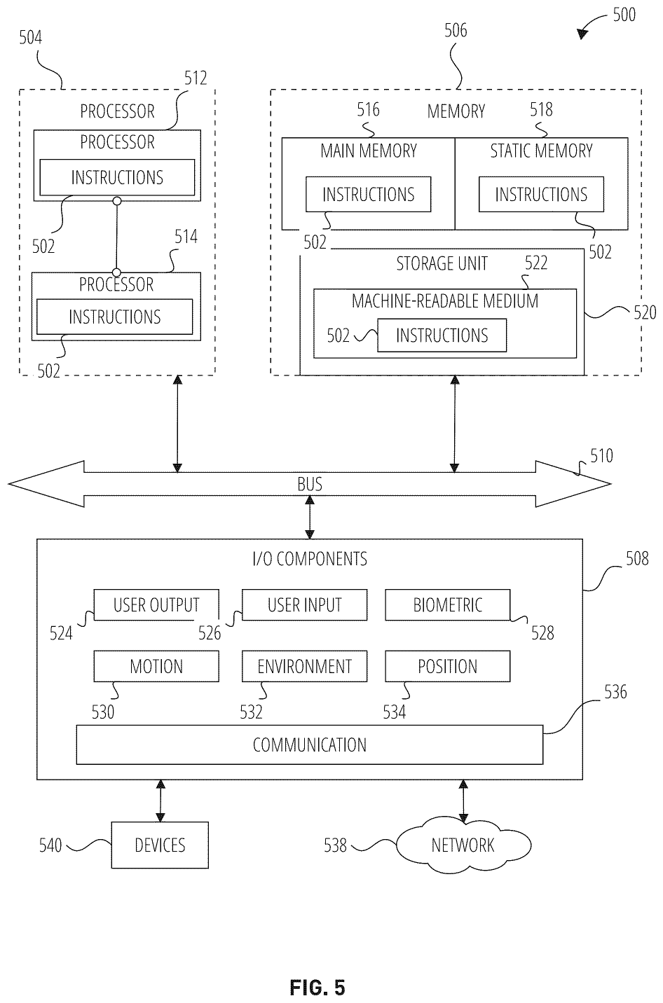

FIG. 5 is a diagrammatic representation of the machine 500 within which instructions 502 (e.g., software, a program, an application, an applet, an app, or other executable code) for causing the machine 500 to perform any one or more of the methodologies discussed herein can be executed. For example, the instructions 502 can cause the machine 500 to execute any one or more of the methods described herein. The instructions 502 transform the general, non-programmed machine 500 into a particular machine 500 programmed to carry out the described and illustrated functions in the manner described. The machine 500 can operate as a standalone device or can be coupled (e.g., networked) to other machines. In a networked deployment, the machine 500 can operate in the capacity of a server machine or a client machine in a server-client network environment, or as a peer machine in a peer-to-peer (or distributed) network environment. The machine 500 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term “machine” shall also be taken to include a collection of machines that individually or jointly execute the instructions 502 to perform any one or more of the methodologies discussed herein. The machine 500, for example, can comprise the user system 302 or any one of multiple server devices forming part of the server system 310. In some examples, the machine 500 can also comprise both client and server systems, with certain operations of a particular method or algorithm being performed on the server-side and with certain operations of the method or algorithm being performed on the client-side.

The machine 500 can include one or more hardware processors 504, memory 506, and input/output I/O components 508, which can be configured to communicate with each other via a bus 510.

The processor 504 can comprise one or more processors such as, but not limited to, processor 512 and processor 514. The one or more processors can comprise one or more types of processing systems such as, but not limited to, Central Processing Units (CPUs), Graphics Processing Units (GPUs), Digital Signal Processors (DSPs), Neural Processing Units (NPUs) or AI Accelerators, Physics Processing Units (PPUs), Field-Programmable Gate Arrays (FPGAs), Multi-core Processors, Symmetric Multiprocessing (SMP) Systems, and the like.

The memory 506 includes a main memory 516, a static memory 518, and a storage unit 520, both accessible to the processor 504 via the bus 510. The main memory 506, the static memory 518, and storage unit 520 store the instructions 502 embodying any one or more of the methodologies or functions described herein. The instructions 502 can also reside, completely or partially, within the main memory 516, within the static memory 518, within machine-readable medium 522 within the storage unit 520, within at least one of the processor 504 (e.g., within the processor's cache memory), or any suitable combination thereof, during execution thereof by the machine 500.

The I/O components 508 can include a wide variety of components to receive input, provide output, produce output, transmit information, exchange information, capture measurements, and so on. The specific I/O components 508 that are included in a particular machine will depend on the type of machine. For example, portable machines such as mobile phones can include a touch input device or other such input mechanisms, while a headless server machine will likely not include such a touch input device. It will be appreciated that the I/O components 508 can include many other components that are not shown in FIG. 5. In various examples, the I/O components 508 can include user output components 524 and user input components 526. The user output components 524 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 508 can include biometric components 528, motion components 530, environmental components 532, or position components 534, among a wide array of other components. For example, the biometric components 528 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data can be used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the data is not shared or sold to any third party without the explicit consent of the user. In addition, appropriate technical and organizational measures are implemented to ensure the security and confidentiality of this sensitive information.

The motion components 530 include acceleration sensor components (e.g., accelerometer), gravitation sensor components, rotation sensor components (e.g., gyroscope).

The environmental components 532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that can provide indications, measurements, or signals corresponding to a surrounding physical environment.

With respect to cameras, the user system 302 can have a camera system comprising, for example, front cameras on a front surface of the user system 302 and rear cameras on a rear surface of the user system 302. The front cameras can, for example, be used to capture still images and video of a user of the user system 302 (e.g., “selfies”), which can then be modified with digital effect data (e.g., filters) described above. The rear cameras can, for example, be used to capture still images and videos in a more traditional camera mode, with these images similarly being modified with digital effect data. In addition to front and rear cameras, the user system 302 can also include a 360° camera for capturing 360° photographs and videos.

Moreover, the camera system of the user system 302 can be equipped with advanced multi-camera configurations. This can include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 302 can also feature triple, quad, or even penta camera configurations on both the front and rear sides of the user system 302. These multiple cameras systems can include a wide camera, an ultra-wide camera, a telephoto camera, a macro camera, and a depth sensor, for example.

Communication can be implemented using a wide variety of technologies. The I/O components 508 further include communication components 536 operable to couple the machine 500 to a Network 538 or devices 540 via respective coupling or connections. For example, the communication components 536 can include a network interface component or another suitable device to interface with the Network 538. In further examples, the communication components 536 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 can be another machine or any of a wide variety of peripheral devices (e.g., a peripheral device coupled via a USB).

Moreover, the communication components 536 can detect identifiers or include components operable to detect identifiers. For example, the communication components 536 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information can be derived via the communication components 536, such as location via Internet Protocol (IP) geolocation, location via Wi-Fi® signal triangulation, location via detecting an NFC beacon signal that can indicate a particular location, and so forth.

The various memories (e.g., main memory 516, static memory 518, and memory of the processor 504) and storage unit 520 can store one or more sets of instructions and data structures (e.g., software) embodying or used by any one or more of the methodologies or functions described herein. These instructions (e.g., the instructions 502), when executed by processor 504, cause various operations to implement the disclosed examples.

The instructions 502 can be transmitted or received over the Network 538, using a transmission medium, via a network interface device (e.g., a network interface component included in the communication components 536) and using any one of several well-known transfer protocols (e.g., hypertext transfer protocol (HTTP)). Similarly, the instructions 502 can be transmitted or received using a transmission medium via a coupling (e.g., a peer-to-peer coupling) to the devices 540.

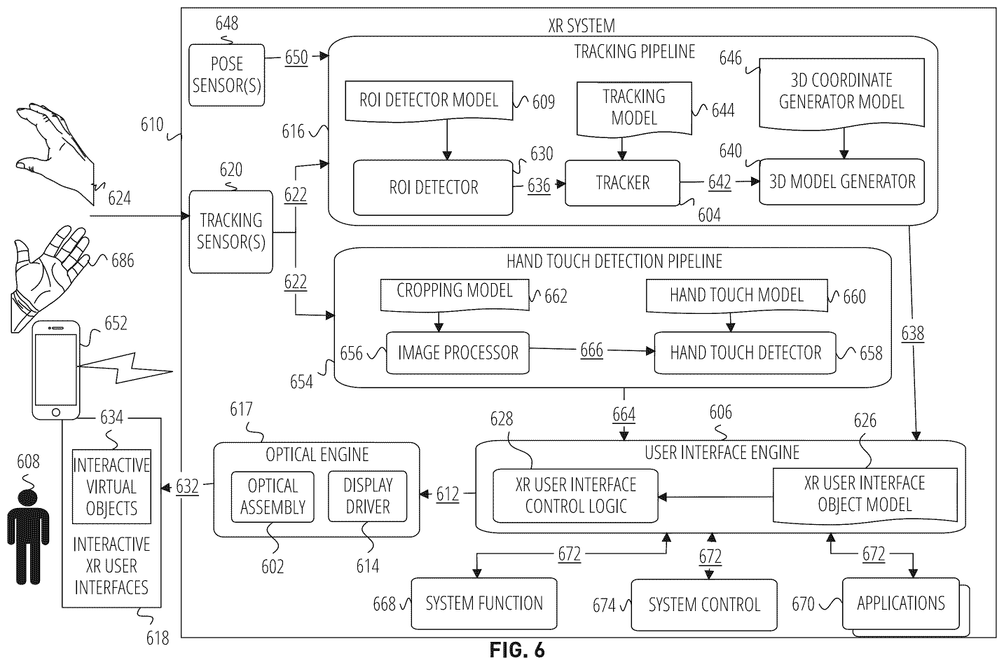

FIG. 6 illustrates a collaboration diagram of components of an XR system 610, such as head-wearable apparatus 100 of FIG. 1A, using hand-tracking for user input, according to some examples.

The XR system 610 uses 3D tracking data 638 and hand touch data 664 to provide a continuous real-time input modalities to a user 608 of the XR system 610 where the user 608 interacts with one or more interactive XR user interfaces 618 using hand-tracking and hand touch input modalities. Using the hand-tracking and hand touch input modalities, the XR system 610 generates user interface input/output (UI I/O) data 672 that are used by a system control component 674, one or more system function components system function component 668, and one or more applications 670 to generate one or more interactive user interfaces displayed as part of the one or more interactive XR user interfaces 618.

The applications 670 are applications that are executed by the XR system 610 and generate application user interfaces that provide features such as, but not limited to, maintenance guides, interactive maps, interactive tour guides, tutorials, and the like. The applications 670 can also be entertainment applications such as, but not limited to, video games, interactive videos, and the like.

The system function components 668 provide interactive XR user interfaces that a user can use to perform various system-level functions. These system-level functions can include, but are not limited to:
Hand-Tracking and Hand touch Recognition Management: Manages configuration of the user input systems, providing real-time feedback through the interactive XR user interface.
Contextual Help and Tips: Offers Contextual help and tips providing relevant assistance based on the user's current activities.
Notification Management: Manages notifications and alerts, ensuring they are presented in a non-intrusive manner and allowing customization of notification settings.
User Customization Settings: Allows users to customize various system settings, including gesture sensitivity and display settings.
Application Management: Handles the launching, switching, and closing of applications, providing a seamless interaction with multiple applications.
Real-Time System Status Updates: Provides real-time updates on system status, such as battery life and connection status.
Security and Privacy Controls: Manages security settings and privacy controls, allowing users to configure these settings and providing prompts about security and privacy issues.

The system control component 674 provides one or more interactive XR user interfaces that provide a consistent user interface for controlling the operating system of the XR system.

The XR system 610 generates the interactive XR user interfaces 618 provided to the user 608 within an XR environment. The interactive XR user interfaces 618 include one or more interactive virtual objects 634 that the user 608 can interact with. For example, a user interface engine 606 of FIG. 6 includes XR user interface control logic 628 comprising a dialog script or the like that specifies a user interface dialog implemented by the interactive XR user interfaces 618. The XR user interface control logic 628 also comprises one or more actions that are to be taken by the XR system 610 based on detecting various dialog events such as user inputs input by the user 608 using the interactive XR user interfaces 618 and by making hand gestures. The user interface engine 606 further includes an XR user interface object model 626. The XR user interface object model 626 includes 3D coordinate data of the one or more interactive virtual objects 634. The XR user interface object model 626 also includes 3D graphics data of the one or more interactive virtual objects 634. The 3D graphics data is used by an optical engine 617 to generate the interactive XR user interfaces 618 for display to the user 608.

The user interface engine 606 generates XR user interface data 612 using the XR user interface object model 626. The XR user interface data 612 includes image data of the one or more interactive virtual objects 634 of the interactive XR user interfaces 618. The user interface engine 606 communicates the XR user interface data 612 to a display driver 614 of an optical engine 617 of the XR system 610. The display driver 614 receives the XR user interface data 612 and generates display control signals using the XR user interface data 612. The display driver 614 uses the display control signals to control the operations of one or more optical assemblies 602 of the optical engine 617. In response to the display control signals, the one or more optical assemblies 602 generate an XR user interface graphics display 632 of the interactive XR user interfaces 618 that are provided to the user 608.

While in use, the XR system 610 uses one or more tracking sensors 620 to detect and record a position, orientation, and gestures of the hands 624 of the user 608. This can involve capturing the speed and trajectory of hand movements, recognizing specific hand poses, and determining the relative positioning of the hands in the three-dimensional space of an XR environment.

In some examples, the one or more tracking sensors 620 comprise an array of optical sensors capable of capturing a wide range of hand movements and gestures in real-time as images. These sensors can include Red Green and Blue (RGB) cameras that capture images of the hands 624 of the user 608 using light having a broad wavelength spectrum, such as natural light provided by the real-world environment or artificial illumination created by one or more incandescent lamps, LED lamps, or the like provided by the XR system 610. In some examples, the one or more tracking sensors 620 can include infrared cameras that capture images of the hands 624 of the user 608 using energy in the infrared radiation (IR) spectrum. The IR energy can be supplied by one or more IR emitters of the XR system 610.

In some examples, the one or more tracking sensors 620 comprise depth-sensing cameras that utilize structured light or time-of-flight technology to create a three-dimensional model of the hands 624 of the user 608. This allows the XR system 610 to detect intricate gestures and finger movements with high accuracy.

In some examples, the one or more tracking sensors 620 comprise ultrasonic sensors that emit sound waves and measure the reflection off the hands 624 of the user 608 to determine their location and movement in space.

In some examples, the one or more tracking sensors 620 comprise electromagnetic field sensors that track the movement of the hands 624 of the user 608 by detecting changes in an electromagnetic field generated around the user 608.

In some examples, the one or more tracking sensors 620 include capacitive sensors embedded in gloves worn by the user 608. These sensors detect hand movements and gestures based on changes in capacitance caused by finger positioning and orientation.

In some examples, the XR system 610 includes one or more pose sensors 648 such as an Inertial Measurement Unit (IMU) and the like, that track the orientation and movements of the XR system of the user 608. The one or more pose sensors 648 are used to determine Six Degrees of Freedom (6 DoF) data of movement of the XR system 610 in three-dimensional space. Specifically, the 6 DoF data encompasses three translational movements along the x, y, and z axes (forward/back, up/down, left/right) and three rotational movements (pitch, yaw, roll) included in pose data 650. In the context of XR, 6 DoF data is allows for the tracking of both position and orientation of an object or user in 3D space.

In some examples, the one or more pose sensors 648 include one or more cameras that capture images of the real-world environment. The images are included in the pose data 650. The XR system 610 uses the images and photogrammetric methodologies to determine 6 DoF data of the XR system 610.

In some examples, the XR system 610 uses a combination of an IMU and one or more cameras to determine 6 DoF for the XR system 610.

The XR system 610 uses a tracking pipeline 616 including a Region Of Interest (ROI) detector 630, a tracker 604, and a 3D model generator 640, to generate the 3D tracking data 638 using the tracking data 622 and the pose data 650.

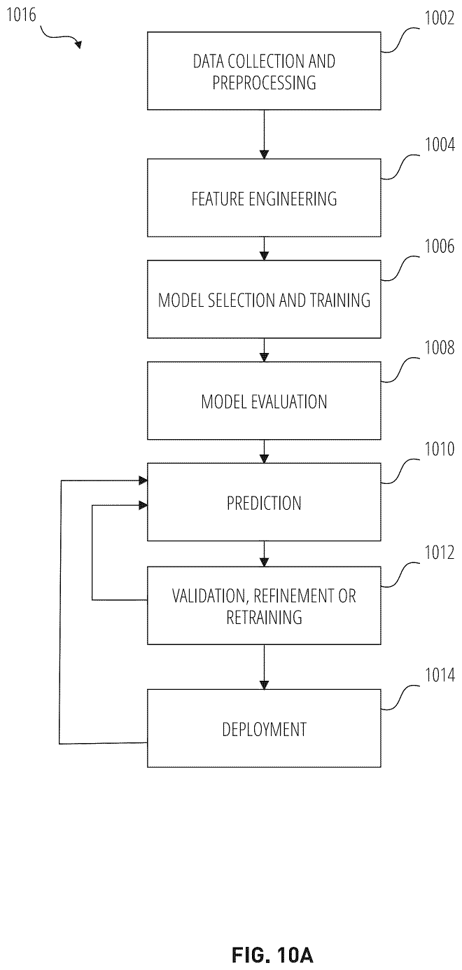

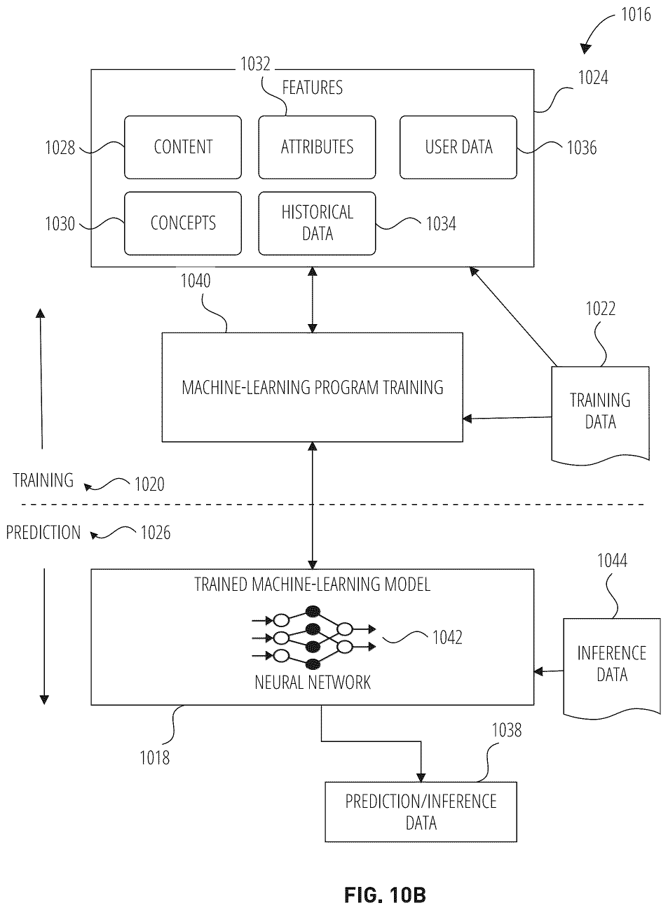

The ROI detector 630 uses a ROI detector model 609 to detect a region in the real world environment that includes a hand 624 of the user 608. The ROI detector model 609 is trained to recognize those portions of the real-world environment that include a user's hands as more fully described in reference to FIG. 10A and FIG. 10B. The ROI detector 630 generates ROI data 636 indicating which portions of the tracking data 622 include one or more hands of the user 608 and communicates the ROI data 636 to the tracker 604.

The tracker 604 uses a tracking model 644 to generate 2D tracking data 642. The tracker 604 uses the tracking model 644 to recognize landmark features at locations on the one or both hands 624 of the user 608 captured in the tracking data 622 and within the ROI identified by the ROI detector 630. The tracker 604 extracts landmarks of the one or both hands 624 of the user 608 from the tracking data 622 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like. The tracking model 644 operates on the landmarks to generate the 2D tracking data 642 that includes a sequence of skeletal models of one or more hands of the user 608. The tracking model 644 is trained to generate the 2D tracking data 642 as more fully described in reference to FIG. 10A and FIG. 10B. The tracker communicates the 2D tracking data 642 to the 3D model generator 640.

The 3D model generator 640 receives the 2D tracking data 642 and generates 3D tracking data 638 using the 2D tracking data 642, the pose data 650, and a 3D coordinate generator model 646. For example, the 3D model generator 640 determines a reference position in the real-world environment for the XR system 610. The 3D model generator 640 uses a 3D coordinate generator model 646 that operates on the 2D tracking data 642 to generate the 3D tracking data 638. The 3D coordinate generator model 646 is trained to generate the 3D tracking data 638 as more fully described in reference to FIG. 10A and FIG. 10B.

In some examples, the tracker 604 generates the 3D tracking data 638 using photogrammetry methodologies to create 3D models of the hands of the user 608 from the 2D tracking data 642 by capturing overlapping pictures of the hands of the user 608 from different angles. In some examples, the 2D tracking data 642 includes multiple images taken from different angles, which are then processed to generate the 3D models that are included in the 3D tracking data 638. In some examples, the XR system 610 uses the pose data 650 captured by one or more pose sensors 648 to determine an angle or position of the XR system 610 as an image is captured of the hands of the user 608.

The XR system 610 uses a hand touch detection pipeline 654 including an image processor 656 and a hand touch detector 658 to generate hand touch data 664 using the tracking data 622.

In some examples, the image processor 656 extracts features from the tracking data 622 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like. The image processor 656 operates on the features to generate the cropped image data 666. The image processor 656 is trained to generate the cropped image data 666 as more fully described in reference to FIG. 10A and FIG. 10B.

In some examples, images in the tracking data 622 are processed by an image processor 656 to enhance the images for better clarity and contrast, making it easier for the XR system 610 to extract features from the tracking data 622. In some examples, the image processor 656 uses image enhancement methodologies such as, but not limited to: histogram equalization, which adjusts the contrast of an image by redistributing the intensity values; Gaussian smoothing, which reduces noise and detail by averaging pixel values with a Gaussian kernel; unsharp mask filtering, which enhances edges by subtracting a blurred version of the image from the original; Wiener filtering, which removes noise and deblurs images by accounting for both the degradation function and the statistical properties of noise; Contrast-Limited Adaptive Histogram Equalization (CLAHE), which improves local contrast and enhances the definition of edges in an image; median filtering, which reduces noise by replacing each pixel's value with the median value of the intensities in its neighborhood; point operations, which apply the same transformation to each pixel based on its original value, such as intensity transformations; spatial filtering, which involves convolution of the image with a kernel to achieve effects like blurring or sharpening; and the like.

In some examples, the image processor 656 filters the images to remove background noise and enhance the visibility of a location of a hand 624 and a digit used by the user 608 to make the hand touch. This processing helps the XR system 610 to accurately detect and interpret the specific interactions intended by the user 608. This capability is useful in complex visual environments where background noise could otherwise interfere with the ability of the XR system 610 to correctly detect a hand touch.

The image processor 656 detects portions of images of the tracking data 622 that include image data of the hands 624 and 686 of the user 608 and crops the images to generate cropped image data 666 including the image data of the hands 624 and 686. The image processor 656 generates the cropped image data 666 and communicates the cropped image data 666 to the hand touch detector 658.

In some examples, the image processor 656 uses a cropping model 662 to crop the images of the tracking data 622 that include image data of the hands 624 and hand 686. Training of the cropping model 662 more fully described in reference to FIG. 10A and FIG. 10B.

In some examples, the image processor 656 uses a hand tracking process to isolate a palmar surface or a hand dorsal surface in images of the hands 624 and 686 of the user 608. This process is useful for focusing the analysis on the most relevant part of a palmar surface or a hand dorsal surface for interaction, which enhances the ability of the XR system 610 to accurately detect and interpret user inputs. By isolating the palmar surface or hand dorsal surface, the XR system 610 can more effectively process and respond to gestures and touches, improving the overall user experience in XR applications. This targeted processing helps in reducing noise and distractions from other parts of the hand or background, improving the precision and reliability of the hand touch detection.

In some examples, the image processor 656 uses the hand tracking process to crop an image to isolate an area around a tip of a digit being used by the user 608 to make a hand touch.

In some examples, the image processor 656 adjusts the cropping of the cropped images to enhance features indicative of the hand touch. This adjustment is useful for improving the accuracy of hand touch detection by focusing on specific areas of the image where hand touch interactions are most likely to occur. By enhancing these features, the XR system 610 can more effectively interpret user inputs, leading to a more responsive and intuitive user experience within the XR environment. This capability is particularly useful for applications requiring precise control and interaction, such as virtual reality gaming or complex navigational tasks in augmented reality settings.

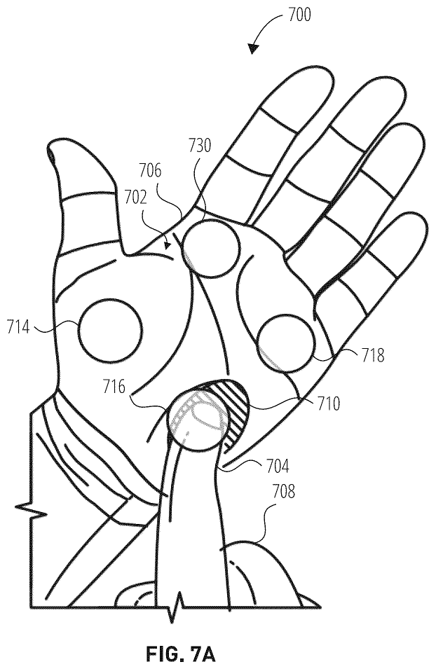

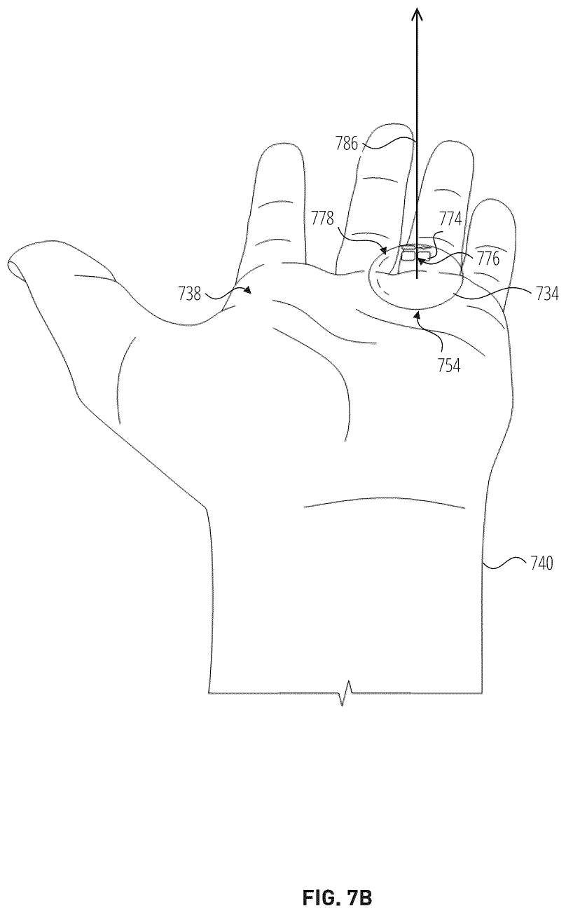

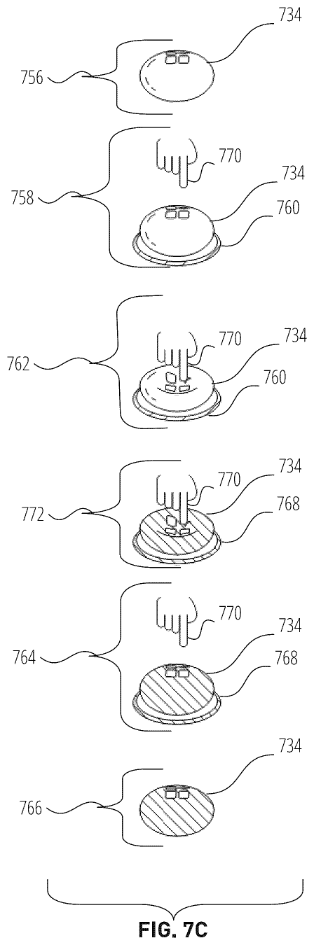

The hand touch detector 658 uses a hand touch model 660 to generate the hand touch data 664. The hand touch detector 658 uses the hand touch model 660 to recognize when the user 608 touches a portion of a first one of their hands 624 and 686 using one or more digits of a second one of their hands 624 and 686. FIG. 7A illustrates a illustrates a hand touch event of a palmar surface 702 of a first hand 706 of a user by a digit 704 of a second hand 708 of the user. As shown, the digit 704 pressing against the palmar surface 702 generates a deformation 710 in a surface of the palmar surface 702 that can be detected using the image data of the palmar surface 702.

In some examples, the location of the hand being touched is the palmar surface of the non-dominant hand of the user and the one or more digits are one or more digits of the dominant hand of the user.

In some examples, the location of the hand being touched is the hand dorsal surface of the non-dominant hand of the user and the one or more digits are one or more digits of the dominant hand of the user.

In some examples, the location of the hand being touched is the palmar surface of the dominant hand of the user and the one or more digits are one or more digits of the non-dominant hand of the user.

In some examples, the location of the hand being touched is the hand dorsal surface of the dominant hand of the user and the one or more digits are one or more digits of the non-dominant hand of the user.

When a hand touch is detected by the hand touch detection pipeline 654, the hand touch detection pipeline 654 communicates hand touch data 664 including data of the hand touch to the user interface engine 606.

The hand touch model 660 is trained to generate the hand touch data 664 as more fully described in reference to FIG. 10A, and FIG. 10B.

In some examples, the hand touch model 660 is retrained using a training data collected by the XR system as the XR system prompts the user 608 to perform specific operations such as, but not limited to, holding a digit over a portion of one their hands, touching specific locations of their hand, and the like. This retraining process is useful for personalizing the model to the specific characteristics and preferences of the user 608. By incorporating user-specific data, the XR system 610 can enhance hand touch accuracy and responsiveness to a user's unique way of interacting with the XR system 610. This capability is particularly beneficial in applications where user comfort and customization improve the overall experience, such as in personalized virtual assistance or adaptive gaming environments.

In some examples, the hand touch detection sensitivity of the hand touch detection pipeline 654 is calibrated using a set of individual hand characteristics of the user 608. This calibration process is useful for tailoring the system's sensitivity to the unique physical attributes of the user's hands, such as size, shape, and touch pressure tendencies.

In some examples, detecting a hand touch of a portion of a hand by a digit of a hand includes interpolating between different hand touch pressure levels detected in the cropped images. For example, the hand touch detector 658 uses the hand touch model 660 to detect variations in visual cues such as, but not limited to, shadowing, indentation, skin deformation, and the like, which are captured in the cropped images. By interpolating these subtle differences, the XR system 610 can determine not just the presence of a touch, but also the varying degrees of pressure applied. In some examples, the hand touch detector 658 generates data of a hand touch that includes a continuous parameter that has a value representing states of a hand touch from a hover state where the user holds a digit in proximity to their hand, to a hard press state where the user touches their hand with a digit and presses hard with that digit. As an example, the continuous value can be a real number having a range from 0.0 to 2.0 where 0.0 represents a hover of a digit over a portion of hand, 1.0 represents a light pressure hand touch, and 2.0 represents a heavy pressure hand touch, and a value between 0.0 and 1.0 represents a distance between the digit and a portion of a hand without a hand touch corresponding to the user 608 holding their digit just above a portion of their hand in a hover position.

In some examples, the XR system generates multiple collider objects for an interactive virtual object. Each collider is assigned a specific radius, which may vary to create different interaction zones around the virtual object. These zones are designed to detect varying degrees of proximity and contact from a digit of the hands 624 and 686 of the user 608. The collider objects on the interactive virtual object are configured with radii that serve specific interaction purposes. Larger radii can be used to detect when the digit is in proximity to the interactive virtual object hovering over the location of the interactive virtual object, triggering a hover event. Smaller, more precisely placed radii can detect direct contact or touch when the digit intersect these smaller collider zones. As the user 608 moves a hand in the physical space, the XR system 610 uses the 3D tracking data 638 to track this movement and translates it into the virtual environment. When the digit enters the radius of a collider on the interactive virtual object, XR system 610 calculates the intersection. If the digit enters a larger radius, a hover event is detected. If the digit intersects with a smaller radius, a touch event is registered.

In some examples, the one or more tracking sensors 620 include one or more visible light cameras such as, but not limited to, RGB cameras, that capture the images of the hands 624 of user 608. The cropped images are processed by the image processor 656 to emphasize depth cues visible in the hands 624 of the user in the RGB spectrum. This processing is useful for enhancing the visual information used for accurately interpreting hand movements and interactions within the XR environment. By emphasizing depth cues, the XR system 610 can more effectively discern the spatial relationships and gestures of the user's hands, leading to more precise and responsive interactions in virtual and augmented reality applications.

In some examples, the XR system 610 is operably connected to a mobile device 652. The user 608 can use the mobile device 652 to configure the XR system 610. In some examples, the mobile device 652 functions as an alternative input modality.

In some examples, an XR system performs the functions of the tracking pipeline 616, the hand touch detection pipeline 654, the user interface engine 606, and the optical engine 617 utilizing various APIs and system libraries.

FIG. 7A illustrates a palmar surface user interface 700, according to some examples. An XR system uses the palmar surface user interface 700 to provide an interactive XR user interface to a user. To do so, the XR system 610 uses the user interface engine 606 of FIG. 6 to generate the palmar surface user interface 700 as more fully described in reference to FIG. 6. As illustrated in FIG. 7A, the palmar surface user interface 700 includes one or more interactive virtual objects 634 including interactive virtual object 714, interactive virtual object 730, interactive virtual object 718, and interactive virtual object 730. 3D location data of the interactive virtual objects of the palmar surface user interface 700 are stored in the XR user interface object model 626.

In some examples, the one or more interactive virtual objects are displayed to the user in association with a respective specified locations of the palmar surface 702 of the hand 706 of the user. For example, an interactive virtual object can be displayed in association with specific fleshy locations of the palmar surface 702 such as, but not limited to, the thenar eminence at the thumb base, the hypothenar eminence at the little finger side of the palmar surface 702, one or more interdigital spaces between fingers, and the like.

Interactive virtual object 714, interactive virtual object 716, interactive virtual object 718, and interactive virtual object 730 are displayed to the user 608 overlaid on the palmar surface 702 of a first hand 706 of the user 608. The user 608 interacts with the interactive virtual object 714, interactive virtual object 716, interactive virtual object 718, and interactive virtual object 730 by touching their palm with a digit 704 of a second or other hand 708 to a location on their palmar surface 702 that corresponds to an apparent location on their palm of the interactive virtual object 714, interactive virtual object 716, interactive virtual object 718, or interactive virtual object 730. As the palmar surface 702 is touched by the digit 704, a deformation 710 is formed in a fleshy part of the palm that can be detected as a hand touch at the location of an interactive object, such as interactive virtual object 716.

In some examples, interactive virtual object 714, interactive virtual object 716, interactive virtual object 718, and interactive virtual object 730 are displayed on a non-dominant hand of the user and the user uses one or more digits of their dominant hand to touch the palm of the non-dominant hand.

In some examples, interactive virtual object 714, interactive virtual object 716, interactive virtual object 718, and interactive virtual object 730 are displayed on a dominant hand of the user and the user uses one or more digits of their non-dominant hand to touch the palm of the dominant hand.

The XR system 610 captures images including images of the hands 706 and 708. For example, the XR system 610 utilizes one or more cameras included in the one or more tracking sensors 620 of the XR system 610 to capture tracking data 622. The tracking data 622 includes images of the hands 706 and 708 of the user 608 as the user 608 interacts with the interactive XR user interfaces 618. For example, the XR system 610 uses the hand touch detector 658 of FIG. 6 to detect the hand touch of the palmar surface 702 of the hand 706 by the digit 704 of the other hand 708 using the hand touch model 660 of FIG. 6 as more fully described in reference to FIG. 6.

The XR system 610 provides the detected hand touch of the palmar surface 702 of the user 608 as an input into the interactive XR user interfaces 618 provided to the user 608. For example, hand touch data 664 including data of the hand touch by the digit 704 to the palmar surface 702 of the hand 706 is communicated to the user interface engine 606 by the hand touch detection pipeline 654. Simultaneously, 3D tracking data 638 including data of the 3D location of the hand 706 including the palmar surface 702, and the digit 704 is communicated to the user interface engine 606 by the tracking pipeline 616. The user interface engine 606 receives the hand touch data 664 from the hand touch detection pipeline 654 and the 3D tracking data 638 from the tracking pipeline 616. The user interface engine 606 uses the data of the hand touch to the palmar surface 702, the data of the 3D location of the hand 706 including the palmar surface 702, and the data of the 3D location of interactive virtual object 714, interactive virtual object 716, interactive virtual object 718, and interactive virtual object 730 stored in the XR user interface object model 626 to determine if the user 608 has touched their palm at a location that corresponds to a location of one or more of the interactive virtual objects 714, 716, 718, and 730. In response to determining that the user 608 has touched their palm a location that corresponds to a location of one or more of the interactive virtual objects 714, 716, 718, and 730, the user interface engine 606 determines that the user 608 has selected and is interacting with the determined interactive virtual object.

In some examples, the one or more interactive virtual objects of the palmar surface user interface 700 may be programmatically assigned to perform various functions based on a context in which the palmar surface user interface 700 is invoked. In addition, icons or images associated with the various respective functions may be displayed on the one or more interactive virtual objects.

In some examples, the palmar surface user interface 700 can be invoked using one or more gestures by a user. For example, the user may close a hand into a fist, turn their fist palm up, and then open the fist such that the palm is pointing up. The XR system 610 detects this sequence of gestures and generates the palmar surface user interface 700 associated with the hand used by the user to make the sequence of one or more gestures.

In some examples, the user can close the palmar surface user interface 700 by making a gesture with the hand associated with the palmar surface user interface 700. For example, the user makes a fist with the hand associated with the palmar surface user interface 700. The XR system 610 detects the closing of the hand into a fist and the XR system 610 closes the palmar surface user interface 700.

FIG. 7B illustrates an interactive virtual object 734 used with an interactive XR user interface and FIG. 7C illustrates states of the interactive virtual object 734 as a user interacts with it, according to some examples. The interactive virtual object 734 can be located on a palmar surface 738 of a hand 740 of a user of an XR system and used as a user input modality.

An XR system renders the interactive virtual object 734 using a set of attributes that define the appearance and behavior of the interactive virtual object 734. Various sets of attributes may be used render the interactive virtual object 734 depending on a state of a function or action of an interactive XR user interface. The different renders can be used to convey the state of the interactive virtual object 734 and/or the interactive XR user interface.

In some examples, the XR system renders the interactive virtual object 734 using a set of attributes to give the appearance that the interactive virtual object 734 is a translucent spheroid made of a gelatinous material, such as jelly or the like. The XR system uses soft body physics to simulate the deformation and movement of the interactive virtual object 734. For example, the XR system generates a 3D spheroid mesh as part of the XR user interface object model 626 of FIG. 6. The XR system determines an interactive virtual object location 754 on the hand 740 where the interactive virtual object 734 will be located and defines the palmar surface 738 as a plane beneath the 3D spheroid. The XR system adds soft body physics to the 3D spheroid as an attribute when the 3D spheroid is animated. The XR system sets a collision attribute to make the palmar surface 738 interact with the soft body 3D spheroid. The XR system generates a soft body simulation for an animation timeline for the 3D spheroid. When rendering an animation, the XR system adds simulated lights to a scene of the animation to highlight the 3D spheroid's translucency and assigns a translucent material to the 3D spheroid. Various animations can be rendered such as, but not limited to:
Deformation Animation: This animation simulates the interactive virtual object 734 deforming in response to interactions, such as a user's touch. The interactive virtual object 734 can compress, expand, or morph its shape to mimic physical interactions similar to a gelatinous material.
Collision Animation: When the interactive virtual object 734 interacts with another object, such as the palmar surface 738 (defined as a plane beneath the sphere), this animation simulates the physical response of the interactive virtual object 734 upon contact, including bouncing, squishing, or other forms of reactive movement.
Soft Body Dynamics: This type of animation allows the interactive virtual object 734 to exhibit properties of a soft body, such as jiggling or wobbling, enhancing the realism of the interactive virtual object 734 as it moves or is manipulated.
Hover Animation: When a user's digit approaches the interactive virtual object 734, the action can trigger a subtle movement or change in the interactive virtual object 734, such as a slight enlargement or a shimmering effect to indicate it is an interactive object.

The choice of a spheroid shape, combined with its translucent nature and gelatinous consistency, allows for an intuitive and visually appealing interface element that can seamlessly integrate into the virtual or augmented reality scene. This design choice not only aids in maintaining the aesthetic continuity of the virtual environment but also supports user engagement by providing a visually distinct and interactive element that is easy to identify and manipulate within an XR environment.

In some examples, the interactive virtual object 734 is rendered using a set of attributes that define the interactive virtual object 734 as a translucent spheroid. In some examples, the translucent spheroid conveys an off idle state 756. The off idle state 756 indicates that a function of the XR system is off and the interactive virtual object 734 is idle.

In some examples, the interactive virtual object 734 is rendered using a set of attributes that define the interactive virtual object 734 as a translucent spheroid with a ring 760 encircling the translucent spheroid of the interactive virtual object 734. In some examples, this indicates an off hover state 758 state where a function associated with the interactive virtual object 734 is off, but the interactive virtual object 734 is active to receive an input, such as by the user poking or pressing the interactive virtual object 734 using a digit 770 of a hand. In some examples, the off hover state 758 is entered when the XR system detects a hover event as a user brings their digit 770 in proximity to the palmar surface 738 of the hand 740 over the location on the palmar surface 738 of the interactive virtual object 734.

In some examples, the XR system uses a set of attributes to render the interactive virtual object 734 as a translucent spheroid that features a dimpled upper surface and is encircled by a ring 760, such as in a pressed off state 762. The dimpled upper surface provides a tactile-like visual cue that can simulate the physical interaction effects when the object is engaged, such as pressing or touching, thereby enriching the user's sensory experience. The encircling ring serves as a visual indicator of the object's active state or focus, further guiding user interaction and engagement with the virtual object. In some examples, the pressed off state 762 is used when the XR system detects a hand touch by a digit 770 of the user at a location on the palmar surface 738 associated with the interactive virtual object 734. The hand touch adds a haptic element to the user input modality that is congruous with the gelatinous appearance of the interactive virtual object 734.

In some examples, the XR system uses a set of attributes to render the interactive virtual object 734 as an internally lighted translucent spheroid that features a dimpled upper surface and is encircled by a lighted ring 768 such as in a pressed on state 772. In some examples, the pressed on state 772 is entered when the XR system detects a hand touch at a location on the palmar surface 738 associated with the interactive virtual object 734.

In some examples, the interactive virtual object 734 is rendered using a set of attributes that define the interactive virtual object 734 as an internally lighted translucent spheroid encircled by a lighted ring 768 such as in an on hover state 764. In some examples, this indicates an on hover state 764 state where a function associated with the interactive virtual object 734 is on and the interactive virtual object 734 is active to receive an input, such as by the user poking or pressing the interactive virtual object 734 using a digit 770 of a hand. In some examples, the on hover state 764 is entered when the XR system detects a hover event as a user brings their digit 770 in proximity to the palmar surface 738 of the hand 740 over the location on the palmar surface 738 of the interactive virtual object 734.

In some examples, the interactive virtual object 734 is rendered using a set of attributes that define the interactive virtual object 734 as an internally lighted translucent spheroid, such as on idle state 766. In some examples, the on idle state 766 is used to convey that a function of the XR system is active and the interactive virtual object 734 is in an idle state.

In some examples, an interactive virtual object 734 includes one or more icons 774 that are displayed with the interactive virtual object 734. The icon 774 can be a 2D icon that is mapped onto a surface 778 of the interactive virtual object 734 at an icon location 776. In some examples, an icon can be a 3D icon that is rendered as if the 3D icon is inside of or projecting from the interactive virtual object 734. The XR system can render and display the one or more icons 774 with the interactive virtual object 734 such that the one or more icons 774 are oriented to be directly visible to the user independently of a position of the hand 740. For example, the XR system can use one or more pose sensors to determine a location of the head of the user. Using the interactive virtual object location 754 and the location of the head of the user, the XR system can determine an orientation vector 786 having an origin point at a center point of the interactive virtual object 734 and projecting to a center point of the head of the user. The XR system renders the icon 774 using the orientation vector 786.

In some examples, in a case of a 2D icon, the XR system determines an icon location 776 at an intersection of the surface 778 of the interactive virtual object and the orientation vector 786. The XR system renders the icon 774 on the surface 778 at the icon location 776.

In some examples, in a case of a 3D icon, the XR system determines a specified surface of the 3D icon to be presented to the user. The XR system aligns the normal vector of the specified surface of the 3D icon with the orientation vector 786 by applying a rotation transformation using quaternions or rotation matrices to rotate the 3D icon to the desired orientation. This ensures the specified surface faces the user.

In some example, the one or more icons 774 or images include one or more status indicators such as messages or the like that are updated to reflect a status of the XR system. In some examples, the one or more status indicators include a time, such as a time of day, day of the week, a date, and the like.

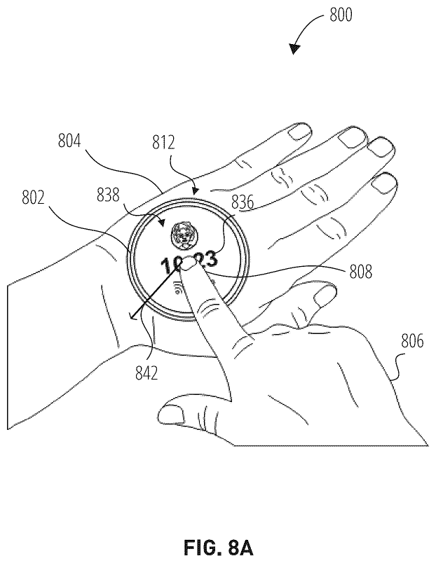

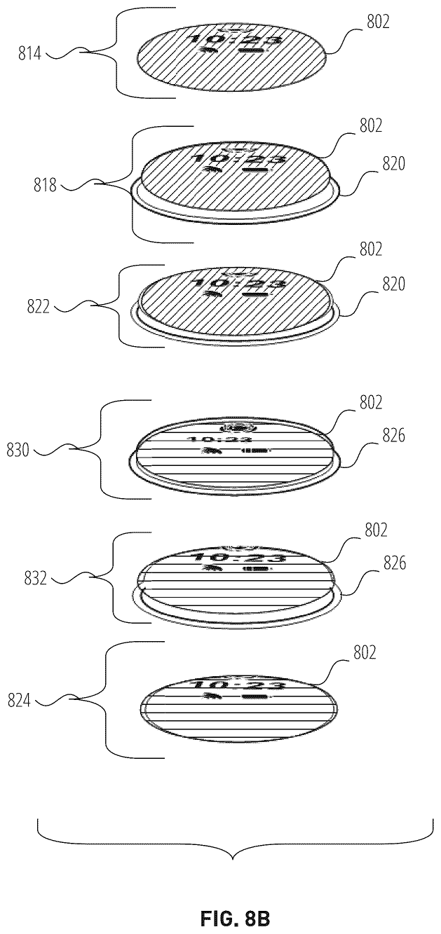

FIG. 8A illustrates a back of hand or hand dorsal surface user interface 800, and FIG. 8B illustrates states of an interactive virtual object 802 of the hand dorsal surface user interface 800 as a user interacts with the hand dorsal surface user interface 800, according to some examples. An XR system 610 of FIG. 6 uses the hand dorsal surface user interface 800 to provide an interactive XR user interface to a user 608 of FIG. 6. To do so, the XR system 610 uses the user interface engine 606 of FIG. 6 to generate the hand dorsal surface user interface 800 as a component of the interactive XR user interfaces 618 as more fully described in reference to FIG. 6. The hand dorsal surface user interface 800 includes one or more interactive virtual objects including interactive virtual object 802. 3D location data of the interactive virtual objects of the hand dorsal surface user interface 800 are stored in the XR user interface object model 626.

In some examples, the XR system renders the interactive virtual object 802 using a set of attributes to give the appearance that the interactive virtual object 802 is a translucent spheroid made of a gelatinous material as more fully described in reference to FIG. 7B.

In some examples, the one or more interactive virtual objects are displayed to the user in association with respective specified locations on the hand dorsal surface 812 of the hand 804 of the user 608. The user 608 interacts with the interactive virtual object 802 by touching the hand dorsal surface 812 with a digit 808 of a second or other hand 806 to a location on the hand dorsal surface 812 that corresponds to an apparent location on the hand dorsal surface 812 of the interactive virtual object 802. As the hand dorsal surface 812 is touched by the digit 808, a deformation is formed on the hand dorsal surface 812 that can be detected as a hand touch at the location of an interactive object, such as the interactive virtual object 802.

In some examples, the interactive virtual object 802 is displayed on a non-dominant hand of the user and the user uses one or more digits of their dominant hand to touch the hand dorsal surface of the non-dominant hand.

In some examples, the interactive virtual object 802 is displayed on a dominant hand of the user and the user uses one or more digits of their non-dominant hand to touch the hand dorsal surface of the dominant hand.

As the user 608 touches the hand dorsal surface 812, the XR system 610 captures images including images of the hands hand 804 and hand 806. For example, the XR system 610 utilizes one or more cameras included in the one or more tracking sensors 620 of the XR system 610 to capture tracking data 622. The tracking data 622 includes images of the hands hand 804 and hand 806 of the user 608 as the user 608 interacts with the interactive XR user interfaces 618. The XR system 610 uses the hand touch detector 658 of FIG. 6 to detect the hand touch of the hand dorsal surface 812 of the hand 706 by the digit 808 of the other hand 806 using the hand touch model 660 of FIG. 6 as more fully described in reference to FIG. 6. The XR system 610 provides the detected hand touch of the hand dorsal surface 812 at the location of the interactive virtual object 802 as an input into the interactive XR user interfaces 618 provided to the user 608.

For example, hand touch data 664 including data of the hand touch by the digit 808 to the hand dorsal surface 812 of the hand 804 is communicated to the user interface engine 606 by the hand touch detection pipeline 654. Simultaneously, 3D tracking data 638 including data of the 3D location of the hand 804 including the hand dorsal surface 812, and the digit 808 is communicated to the user interface engine 606 by the tracking pipeline 616. The user interface engine 606 receives the hand touch data 664 from the hand touch detection pipeline 654 and the 3D tracking data 638 from the tracking pipeline 616. The user interface engine 606 uses the data of the hand touch to the hand dorsal surface 812, the data of the 3D location of the hand 804 including the hand dorsal surface 812, and the data of the 3D location of the interactive virtual object 802 to determine if the user 608 has touched the hand dorsal surface 812 at a location that corresponds to a location of the interactive virtual object 802. In response to determining that the user 608 has touched the hand dorsal surface 812 at a location that corresponds to a location of the interactive virtual object 802, the user interface engine 606 determines that the user 608 has selected and is interacting with the determined interactive virtual object.

In some examples, the one or more interactive virtual objects of the hand dorsal surface user interface 800 may be programmatically assigned to perform various functions based on a context in which the hand dorsal surface user interface 800 is invoked. In addition, icons or images associated with the various respective functions may be displayed on the one or more interactive virtual objects.

In some examples, hand dorsal surface user interface 800 can be invoked using one or more gestures by a user. For example, the user may turn their hand 804 so that the hand dorsal surface 812 faces upward and flattens their hand 804 so that their fingers are extended. The XR system 610 detects this sequence of one or more gestures and generates the hand dorsal surface user interface 800 associated with the hand used by the user to make the sequence of one or more gestures.

In some examples, the user closes the hand dorsal surface user interface 800 by making a gesture with the hand 804 associated with the hand dorsal surface user interface 800. For example, the user turns their hand 804 so that the hand dorsal surface 812 is no longer facing upward while also relaxing their fingers. The XR system 610 detects the turning of the hand 804 and relaxation of the fingers and closes the hand dorsal surface user interface 800.

An XR system renders the interactive virtual object 802 using a set of attributes that define the appearance and behavior of the interactive virtual object 802. Various sets of attributes can be used render the interactive virtual object 802 depending on a state of a function or action of an interactive XR user interface. The different renders can be used to convey the state of the interactive virtual object 802 and/or the interactive XR user interface as more fully described in reference to FIG. 7B and FIG. 7C.

In some examples, the interactive virtual object 802 is rendered using a set of attributes that define the interactive virtual object 802 as a translucent oblate spheroid. In some examples, the translucent oblate spheroid conveys an off idle state 814.

In some examples, the interactive virtual object 802 is rendered using a set of attributes that define the interactive virtual object 802 as a translucent oblate spheroid with a ring 820 encircling the translucent oblate spheroid. In some examples, this indicates an off hover state 818. In some examples, the off hover state 818 is entered when the XR system detects a hover event as a user brings their digit 808 in proximity to the hand dorsal surface 812 of the hand 804 over the location on the hand dorsal surface 812 of the interactive virtual object 802.

In some examples, the XR system uses a set of attributes to render the interactive virtual object 802 as a translucent oblate spheroid that features a dimpled upper surface and is encircled by a ring 820, such as in a pressed off state 822. In some examples, the pressed off state 822 is entered when the XR system detects a hand touch by a digit 808 of the user at a location on the hand dorsal surface 812 associated with the interactive virtual object 802.

In some examples, the XR system uses a set of attributes to render the interactive virtual object 802 as an internally lighted translucent oblate spheroid that features a dimpled upper surface and is encircled by a lighted ring 826 such as in a pressed on state 830. In some examples, the pressed on state 830 is entered when the XR system detects a hand touch at a location on the hand dorsal surfaces 812 associated with the interactive virtual object 802.

In some examples, the interactive virtual object 802 is rendered using a set of attributes that define the interactive virtual object 802 as an internally lighted translucent oblate spheroid encircled by a lighted ring 826 such as in an on hover state 832. In some examples, the on hover state 832 is entered when the XR system detects a hover event as a user brings their digit 808 in proximity to the hand dorsal surface 812 of the hand 804 over the location on the hand dorsal surface 812 of the interactive virtual object 802.

In some examples, the interactive virtual object 802 is rendered using a set of attributes that define the interactive virtual object 802 as an internally lighted translucent oblate spheroid, such as on idle state 824.

In some examples, an interactive virtual object 802 includes one or more icons 836 or images that are rendered and displayed with the interactive virtual object 802. The icons 836 can be 2D icons that are mapped onto a surface 838 of the interactive virtual object 802 at an icon location. In some examples, an icon can be a 3D icon that is rendered as if the 3D icon is inside of or projecting from the interactive virtual object 802. The XR system can render and display the one or more icons 836 with the interactive virtual object 802 such that the one or more icons 836 are oriented to be directly visible to the user independently of a position of the hand 804.

For example, the XR system can use one or more pose sensors to determine a location of the head of the user. Using the location of the interactive virtual object 802 and the location of the head of the user, the XR system can determine an orientation vector 842 having an origin point at a center point of the interactive virtual object 802 and projecting to a center point of the head of the user. The XR system renders the one or more icons 836 using the orientation vector 842.

In some examples, in a case of a 2D icon, the XR system determines an icon location at an intersection of the surface 838 of the interactive virtual object 802 and the orientation vector 842. The XR system renders the one or more icons 836 on the surface 838 at the icon location.

In some examples, in a case of a 3D icon, the XR system determines a specified surface of the 3D icon to be presented to the user. The XR system aligns the normal vector of the specified surface of the 3D icon with the orientation vector 842 by applying a rotation transformation using quaternions or rotation matrices to rotate the 3D icon to the desired orientation. This ensures the specified surface faces the user.

In some example, the one or more icons 836 or images include one or more status indicators such as messages or the like that are updated to reflect a status of the XR system. In some examples, the one or more status indicators include a time, such as a time of day, day of the week, a date, and the like.

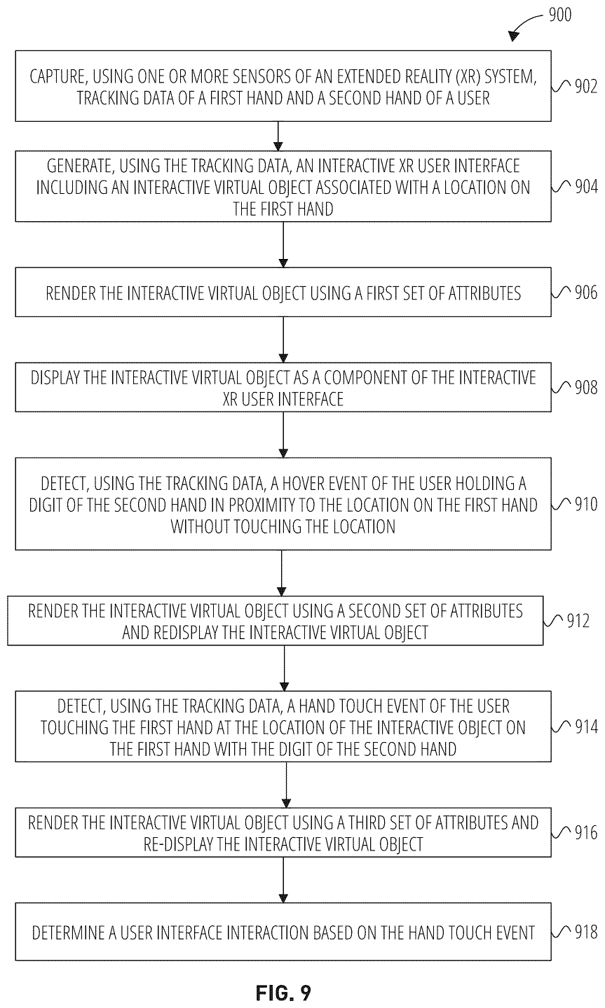

FIG. 9 illustrates an example interactive virtual object method 900, according to some examples. An XR system, such as XR system 610 of FIG. 6, uses the interactive virtual object method 900 as a process within an interactive XR user interface. Although the example interactive virtual object method 900 depicts a particular sequence of operations, the sequence may be altered without departing from the scope of the present disclosure. For example, some of the operations depicted may be performed in parallel or in a different sequence that does not materially affect the function of the interactive virtual object method 900. In other examples, different components of an XR system that implements the interactive virtual object method 900 may perform functions at substantially the same time or in a specific sequence.

In operation 902, the XR system captures, using one or more sensors, tracking data of a first hand and a second hand of a user. For example, in reference to FIG. 6, the XR system 610 captures tracking data 622 and pose data 650 using one or more tracking sensors 620 and one or more pose sensors 648. The XR system uses a tracking pipeline 616 to generate 3D tracking data 638 from the tracking data 622 and the pose data 650 as more fully described in FIG. 6.

In operation 904, the XR system generates, using the tracking data, an interactive XR user interface including an interactive virtual object associated with a location on the first hand.

In some examples, in reference to FIG. 7A, the interactive XR user interface is a palmar surface user interface 700. The palmar surface user interface 700 includes one or more interactive virtual objects including interactive virtual object 714, interactive virtual object 730, interactive virtual object 718, and interactive virtual object 730. In some examples, the one or more interactive virtual objects are displayed to the user in association with respective specified locations on the palmar surface 702 of the hand 706 of the user as more fully described in FIG. 7A.

In some examples, in reference to FIG. 8A, the interactive XR user interface can be a hand dorsal surface user interface 800. The hand dorsal surface user interface 800 includes one or more interactive virtual objects including interactive virtual object 802. In some examples, the one or more interactive virtual objects are displayed to the user in association with a specified location on the hand dorsal surface 812 of the hand 804 of the user. The user interacts with the interactive virtual object 802 by touching the hand dorsal surface 812 with a digit 808 of a second or other hand 806 to a location on the hand dorsal surface 812 that corresponds to an apparent location on the hand dorsal surface 812 of the interactive virtual object 802 as more fully described in reference to FIG. 9.

In operation 906, the XR system renders the interactive virtual object using a first set of attributes. In some examples, as more fully described in reference to FIG. 7C, the interactive virtual object can be an interactive virtual object 734 that is modeled as a gelatinous translucent spheroid using a set of attributes that define a state such as, but not limited to, an off idle state 756, an on idle state 766, and the like.

In some examples, as more fully described in reference to FIG. 8B, the interactive virtual object can be an interactive virtual object 802 that is modeled as a gelatinous translucent oblate spheroid using a set of attributes that define a state such as, but not limited to, an off idle state 814, an on idle state 824, and the like.

In operation 908, the XR system displays the interactive virtual object as a component of the interactive XR user interface. For example, in reference to FIG. 6, a user interface engine 606 generates XR user interface data 612 using an XR user interface object model 626. The XR user interface data 612 includes image data of the one or more interactive virtual objects 634 of the interactive XR user interfaces 618. The user interface engine 606 communicates the XR user interface data 612 to a display driver 614 of an optical engine 617 of the XR system 610. The display driver 614 receives the XR user interface data 612 and generates display control signals using the XR user interface data 612. The display driver 614 uses the display control signals to control the operations of one or more optical assemblies 602 of the optical engine 617. In response to the display control signals, the one or more optical assemblies 602 generate an XR user interface graphics display 632 of the interactive XR user interfaces 618 that are provided to the user 608 as more fully described in reference to FIG. 6.

In operation 910, the XR system detects, using the tracking data, a hover event of the user holding a digit of the second hand in proximity to the location on the first hand without touching the location. For example, in reference to FIG. 6, an XR system uses a hand touch detection pipeline 654 including an image processor 656 and a hand touch detector 658 to generate hand touch data 664 using the tracking data 622. The hand touch detector 658 generates the hand touch data 664 that includes a continuous parameter that has a value representing states of a hand touch from a hover state where the user holds a digit in proximity to their hand, to a hard press state where the user touches their hand with a digit and presses hard with that digit as more fully described in reference to FIG. 6.

In operation 912, in response to detecting the hover event, the XR system renders the interactive virtual object using a second set of attributes and re-displays the interactive virtual object to the user in the interactive XR user interface. In some examples, as more fully described in reference to FIG. 7C, the interactive virtual object can be an interactive virtual object 734 that is modeled as a gelatinous translucent spheroid using a set of attributes that define a state such as, but not limited to, an off hover state 758, an on hover state 764, and the like.

In some examples, as more fully described in reference to FIG. 8B, the interactive virtual object can be an interactive virtual object 802 that is modeled as a gelatinous translucent oblate spheroid using a set of attributes that define a state such as, but not limited to, an off hover state 818, an on hover state 832, and the like.

In some examples, in response to detecting the hover event, the XR system can use the hover event as a user input into the interactive XR user interface and perform a function, action, process, or the like of the XR system associated with the user input.

In operation 914, the XR system detects, using the tracking data, a hand touch event of the user touching the first hand at the location of the interactive object on the first hand with the digit of the second hand. For example, in reference to FIG. 6, an XR system uses a hand touch detection pipeline 654 including an image processor 656 and a hand touch detector 658 to generate hand touch data 664 using the tracking data 622. The hand touch data 664 includes a continuous parameter that has a value representing states of a hand touch from a hover state where the user holds a digit in proximity to their hand, to a hard press state where the user touches their hand with a digit and presses hard with that digit as more fully described in reference to FIG. 6.

In operation 916, in response to detecting the hand touch event, the XR system renders the interactive virtual object using a third set of attributes and re-displays the interactive virtual object. In some examples, as more fully described in reference to FIG. 7C, the interactive virtual object can be an interactive virtual object 734 that is modeled as a gelatinous translucent spheroid using a set of attributes that define a state such as, but not limited to, a pressed off state 762, a pressed on state 772, and the like.

In some examples, as more fully described in reference to FIG. 8B, the interactive virtual object can be an interactive virtual object 802 that is modeled as a gelatinous translucent oblate spheroid using a set of attributes that define a state such as, but not limited to, a pressed on state 830, a pressed off state 822, and the like.

In operation 918, the XR system determines a user interface interaction based on the hand touch event. For example, in response to detecting the hand touch event, the XR system can use the hand touch event as a user input into the interactive XR user interface and perform a function, action, process, or the like of the XR system associated with the user input.

### Machine-Learning Pipeline

FIG. 10B is a flowchart depicting a machine-learning pipeline 1016, according to some examples. The machine-learning pipeline 1016 can be used to generate a trained machine-learning model 1018 such as, but not limited to ROI detector model 609 of FIG. 6, tracking model 644 of FIGS. 6, 3D coordinate generator model 646 of FIG. FIG. 6, cropping model 662 of FIG. 6, hand touch model 660 of FIG. 6, and the like, to perform operations associated with determining user inputs into an XR system, such as XR system 610 of FIG. 6.

Machine learning can involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that can be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting can be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

Generating a trained machine-learning model 1018 can include multiple phases that form part of the machine-learning pipeline 1016, including for example the following phases illustrated in FIG. 10A:
Data collection and preprocessing 1002: This phase can include acquiring and cleaning data to ensure that it is suitable for use in the machine learning model. This phase can also include removing duplicates, handling missing values, and converting data into a suitable format.
Feature engineering 1004: This phase can include selecting and transforming the training data 1022 to create features that are useful for predicting the target variable. Feature engineering can include (1) receiving features 1024 (e.g., as structured or labeled data in supervised learning) and/or (2) identifying features 1024 (e.g., unstructured or unlabeled data for unsupervised learning) in training data 1022.
Model selection and training 1006: This phase can include selecting an appropriate machine learning algorithm and training it on the preprocessed data. This phase can further involve splitting the data into training and testing sets, using cross-validation to evaluate the model, and tuning hyperparameters to improve performance.
Model evaluation 1008: This phase can include evaluating the performance of a trained model (e.g., the trained machine-learning model 1018) on a separate testing dataset. This phase can help determine if the model is overfitting or underfitting and determine whether the model is suitable for deployment.
Prediction 1010: This phase involves using a trained model (e.g., trained machine-learning model 1018) to generate predictions on new, unseen data.
Validation, refinement or retraining 1012: This phase can include updating a model based on feedback generated from the prediction phase, such as new data or user feedback.
Deployment 1014: This phase can include integrating the trained model (e.g., the trained machine-learning model 1018) into a more extensive system or application, such as a web service, mobile app, or IoT device. This phase can involve setting up APIs, building a user interface, and ensuring that the model is scalable and can handle large volumes of data.

FIG. 10B illustrates further details of two example phases, namely a training phase 1020 (e.g., part of the model selection and trainings 1006) and a prediction phase 1026 (part of prediction 1010). Prior to the training phase 1020, feature engineering 1004 is used to identify features 1024. This can include identifying informative, discriminating, and independent features for effectively operating the trained machine-learning model 1018 in pattern recognition, classification, and regression. In some examples, the training data 1022 includes labeled data, known for pre-identified features 1024 and one or more outcomes. Each of the features 1024 can be a variable or attribute, such as an individual measurable property of a process, article, system, or phenomenon represented by a data set (e.g., the training data 1022). Features 1024 can also be of different types, such as numeric features, strings, and graphs, and can include one or more of content 1028, concepts 1030, attributes 1032, historical data 1034, and/or user data 1036, merely for example.

In training phase 1020, the machine-learning pipeline 1016 uses the training data 1022 to find correlations among the features 1024 that affect a predicted outcome or prediction/inference data 1038.

With the training data 1022 and the identified features 1024, the trained machine-learning model 1018 is trained during the training phase 1020 during machine-learning program training 1040. The machine-learning program training 1040 appraises values of the features 1024 as they correlate to the training data 1022. The result of the training is the trained machine-learning model 1018 (e.g., a trained or learned model).

Further, the training phase 1020 can involve machine learning, in which the training data 1022 is structured (e.g., labeled during preprocessing operations). The trained machine-learning model 1018 implements a neural network 1042 capable of performing, for example, classification and clustering operations. In other examples, the training phase 1020 can involve deep learning, in which the training data 1022 is unstructured, and the trained machine-learning model 1018 implements a deep neural network 1042 that can perform both feature extraction and classification/clustering operations.

In some examples, a neural network 1042 can be generated during the training phase 1020, and implemented within the trained machine-learning model 1018. The neural network 1042 includes a hierarchical (e.g., layered) organization of neurons, with each layer consisting of multiple neurons or nodes. Neurons in the input layer receive the input data, while neurons in the output layer produce the final output of the network. Between the input and output layers, there can be one or more hidden layers, each consisting of multiple neurons.

Each neuron in the neural network 1042 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks can use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1042 can also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1020, a validation phase can be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model can be tested on a new dataset. The testing dataset is used to evaluate the model's performance and ensure that the model has not overfitted the training data.

In prediction phase 1026, the trained machine-learning model 1018 uses the features 1024 for analyzing inference data 1044 to generate inferences, outcomes, or predictions, as examples of a prediction/inference data 1038. For example, during prediction phase 1026, the trained machine-learning model 1018 generates an output. Inference data 1044 is provided as an input to the trained machine-learning model 1018, and the trained machine-learning model 1018 generates the prediction/inference data 1038 as output, responsive to receipt of the inference data 1044.

In some examples, the trained machine-learning model 1018 can be a generative AI model. Generative AI is a term that can refer to any type of artificial intelligence that can create new content from training data 1022. For example, generative AI can produce text, images, video, audio, code, or synthetic data similar to the original data but not identical. In cases where the trained machine-learning model 1018 is a generative AI, inference data 1044 can include text, audio, image, video, numeric, or media content prompts and the output prediction/inference data 1038 can include text, images, video, audio, code, or synthetic data.

Some of the techniques that can be used in generative AI are:
Convolutional Neural Networks (CNNs): CNNs can be used for image recognition and computer vision tasks. CNNs can, for example, be designed to extract features from images by using filters or kernels that scan the input image and highlight important patterns.
Recurrent Neural Networks (RNNs): RNNs can be used for processing sequential data, such as speech, text, and time series data, for example. RNNs employ feedback loops that allow them to capture temporal dependencies and remember past inputs.
Generative adversarial networks (GANs): GANs can include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs can encode input data into a latent space (e.g., a compressed representation) and then decode it back into output data. The latent space can be manipulated to generate new variations of the output data. VAEs can use self-attention mechanisms to process input data, allowing them to handle long text sequences and capture complex dependencies.
Transformer models: Transformer models can use attention mechanisms to learn the relationships between different parts of input data (such as words or pixels) and generate output data based on these relationships. Transformer models can handle sequential data, such as text or speech, as well as non-sequential data, such as images or code.

Described implementations of the subject matter can include one or more features, alone or in combination as illustrated below by way of example.

Example 1 is a machine-implemented method, comprising: capturing, using one or more sensors of an eXtended Reality (XR) system, tracking data of a first hand and a second hand of a user; while continuing to capture the tracking data, performing first operations comprising: generating, using the tracking data, an interactive XR user interface including an interactive virtual object associated with a location on the first hand; rendering the interactive virtual object using a first set of attributes; displaying the interactive virtual object as a component of the interactive XR user interface; detecting, using the tracking data, a hover event of the user holding a digit of the second hand in proximity to the location on the first hand without touching the location; and in response to detecting the hover event, performing second operations comprising: rendering of the interactive virtual object using a second set of attributes; and re-displaying the interactive virtual object as a component of the interactive XR user interface.

In Example 2, the subject matter of Example 1 includes, wherein the first set of attributes comprise rendering the interactive virtual object as a translucent spheroid.

In Example 3, the subject matter of any of Examples 1-2 includes, wherein the first set of attributes comprise rendering the interactive virtual object as an internally lighted translucent spheroid.

In Example 4, the subject matter of any of Examples 1-3 includes, wherein the second set of attributes comprise rendering the interactive virtual object as a translucent spheroid encircled by a ring.

In Example 5, the subject matter of any of Examples 1-4 includes, wherein the second set of attributes comprise rendering the interactive virtual object as an internally lighted translucent spheroid encircled by a light emitting ring.

In Example 6, the subject matter of any of Examples 1-5 includes, detecting, using the tracking data, a hand touch event of the user touching the first hand at the location on the first hand with the digit of the second hand; and in response to detecting the hand touch event, performing third operations comprising: rendering of the interactive virtual object using a third set of attributes; re-displaying the interactive virtual object to the user; and determining a user interface interaction based on the hand touch event at the location.

In Example 7, the subject matter of any of Example 1-6 includes, wherein the third set of attributes include rendering the interactive virtual object as a translucent spheroid having a dimpled upper surface and encircled by a ring.

In Example 8, the subject matter of any of Examples 1-7 includes, wherein the third set of attributes include rendering the interactive virtual object as an internally lighted translucent spheroid having a dimpled upper surface and encircled by a light emitting ring.

In Example 9, the subject matter of any of Examples 1-8 includes, wherein the interactive virtual object comprises one or more icons, and wherein the method further comprises: rendering and displaying the one or more icons oriented to be visible to the user independently of a position of the first hand.

In Example 10, the subject matter of any of Examples 1-9 includes, wherein the XR system is a head-wearable apparatus.

Example 11 is at least one machine-readable medium including instructions that, when executed by processing circuitry, cause the processing circuitry to perform operations to implement of any of Examples 1-10.

Example 12 is an apparatus comprising means to implement of any of Examples 1-10.

Example 13 is a system to implement of any of Examples 1-10.

Example 14 is a method to implement of any of Examples 1-10.

The various features, operations, or processes described herein can be used independently of one another, or can be combined in various ways. All possible combinations and sub-combinations are intended to fall within the scope of this disclosure. In addition, certain method or process blocks can be omitted in some implementations.

Although some examples, e.g., those depicted in the drawings, include a particular sequence of operations, the sequence can be altered without departing from the scope of the present disclosure. For example, some of the operations depicted can be performed in parallel or in a different sequence that does not materially affect the functions as described in the examples. In other examples, different components of an example device or system that implements an example method can perform functions at substantially the same time or in a specific sequence.

Changes and modifications can be made to the disclosed examples without departing from the scope of the present disclosure. These and other changes or modifications are intended to be included within the scope of the present disclosure, as expressed in the appended claims.

### Term Examples

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number can also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

“Carrier signal” can include, for example, any intangible medium that can store, encoding, or carrying instructions for execution by the machine and includes digital or analog communications signals or other intangible media to facilitate communication of such instructions. Instructions can be transmitted or received over a network using a transmission medium via a network interface device.

“Client device” can include, for example, any machine that interfaces to a network to obtain resources from one or more server systems or other client devices. A client device can be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user can use to access a network.

“Component” can include, for example, a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein. A hardware component can also be implemented mechanically, electronically, or any suitable combination thereof. For example, a hardware component can include dedicated circuitry or logic that is permanently configured to perform certain operations. A hardware component can be a special-purpose processor, such as a field-programmable gate array (FPGA) or an application-specific integrated circuit (ASIC). A hardware component can also include programmable logic or circuitry that is temporarily configured by software to perform certain operations. For example, a hardware component can include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” can refer to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some examples, the processors or processor-implemented components can be located in a single geographic location (e.g., within a home environment, an office environment, or a server farm). In other examples, the processors or processor-implemented components can be distributed across a number of geographic locations.

“Computer-readable medium” can include, for example, both machine-storage media and signal media. Thus, the terms include both storage devices/media and carrier waves/modulated data signals. The terms “machine-readable medium,” “computer-readable medium” and “device-readable medium” mean the same thing and can be used interchangeably in this disclosure.

“Machine-storage medium” can include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine-storage medium can also refer to cloud storage services, Network Attached Storage (NAS), Storage Area Networks (SAN), and object storage devices. The terms “machine-storage medium,” “device-storage medium,” “computer-storage medium” mean the same thing and can be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” can include, for example, one or more portions of a network that can be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network can include a wireless or cellular network, and the coupling can be a Code Division Multiple Access (CDMA) connection, a Global System for Mobile communications (GSM) connection, or other types of cellular or wireless coupling. In this example, the coupling can implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable medium” can include, for example, a tangible medium that is capable of storing, encoding, or carrying the instructions for execution by a machine.

“Processor” can include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” can include multi-core processors that can comprise two or more independent processors (sometimes referred to as “cores”) that can execute instructions contemporaneously. These cores can be homogeneous (e.g., all cores are identical, as in multicore CPUs) or heterogeneous (e.g., cores are not identical, as in many modern GPUs and some CPUs). In addition, the term “processor” can also encompass systems with a distributed architecture, where multiple processors are interconnected to perform tasks in a coordinated manner. This includes cluster computing, grid computing, and cloud computing infrastructures. Furthermore, the processor can be embedded in a device to control specific functions of that device, such as in an embedded system, or it can be part of a larger system, such as a server in a data center. The processor can also be virtualized in a software-defined infrastructure, where the processor's functions are emulated in software.

“Signal medium” can include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium”mean the same thing and can be used interchangeably in this disclosure.

“User device” can include, for example, a device accessed, controlled or owned by a user and with which the user interacts perform an action, engagement or interaction on the user device, including an interaction with other users or computer systems.

What is claimed is:

1. A machine-implemented method, comprising:
capturing, using one or more sensors of an eXtended Reality (XR) system, tracking data of a first hand and a second hand of a user;
while continuing to capture the tracking data, performing first operations comprising:
generating, using the tracking data, an interactive XR user interface including an interactive virtual object associated with a location on the first hand;
rendering the interactive virtual object using a first set of attributes;
displaying the interactive virtual object as a component of the interactive XR user interface;
detecting, using the tracking data, a hover event of the user holding a digit of the second hand in proximity to the location on the first hand without touching the location; and
in response to detecting the hover event, performing second operations comprising:
rendering of the interactive virtual object using a second set of attributes; and
re-displaying the interactive virtual object as a component of the interactive XR user interface.

2. The machine-implemented method of claim 1, wherein the first set of attributes comprise rendering the interactive virtual object as a translucent spheroid.

3. The machine-implemented method of claim 1, wherein the first set of attributes comprise rendering the interactive virtual object as an internally lighted translucent spheroid.

4. The machine-implemented method of claim 1, wherein the second set of attributes comprise rendering the interactive virtual object as a translucent spheroid encircled by a ring.

5. The machine-implemented method of claim 1, wherein the second set of attributes comprise rendering the interactive virtual object as an internally lighted translucent spheroid encircled by a light emitting ring.

6. The machine-implemented method of claim 1, further comprising:
detecting, using the tracking data, a hand touch event of the user touching the first hand at the location on the first hand with the digit of the second hand; and
in response to detecting the hand touch event, performing third operations comprising:
rendering of the interactive virtual object using a third set of attributes;
re-displaying the interactive virtual object to the user; and
determining a user interface interaction based on the hand touch event at the location.

7. The machine-implemented method of claim 6, wherein the third set of attributes include rendering the interactive virtual object as a translucent spheroid having a dimpled upper surface and encircled by a ring.

8. The machine-implemented method of claim 6, wherein the third set of attributes include rendering the interactive virtual object as an internally lighted translucent spheroid having a dimpled upper surface and encircled by a light emitting ring.

9. The machine-implemented method of claim 1,
wherein the interactive virtual object comprises one or more icons, and
wherein the method further comprises:
rendering and displaying the one or more icons oriented to be visible to the user independently of a position of the first hand.

10. The machine-implemented method of claim 1, wherein the XR system is a head-wearable apparatus.

11. A machine comprising:
at least one processor; and
at least one memory storing instructions that, when executed by the at least one processor, cause the machine to perform operations comprising:
capturing, using one or more sensors of an eXtended Reality (XR) system, tracking data of a first hand and a second hand of a user;
while continuing to capture the tracking data, performing first operations comprising:
generating, using the tracking data, an interactive XR user interface including an interactive virtual object associated with a location on the first hand;
rendering the interactive virtual object using a first set of attributes;
displaying the interactive virtual object as a component of the interactive XR user interface;
detecting, using the tracking data, a hover event of the user holding a digit of the second hand in proximity to the location on the first hand without touching the location; and
in response to detecting the hover event, performing second operations comprising:
rendering of the interactive virtual object using a second set of attributes; and
re-displaying the interactive virtual object as a component of the interactive XR user interface.

12. The machine of claim 11, wherein the first set of attributes comprise rendering the interactive virtual object as a translucent spheroid.

13. The machine of claim 11, wherein the first set of attributes comprise rendering the interactive virtual object as an internally lighted translucent spheroid.

14. The machine of claim 11, wherein the second set of attributes comprise rendering the interactive virtual object as a translucent spheroid encircled by a ring.

15. The machine of claim 11, wherein the second set of attributes comprise rendering the interactive virtual object as an internally lighted translucent spheroid encircled by a light emitting ring.

16. The machine of claim 11, wherein the operations further comprise:
detecting, using the tracking data, a hand touch event of the user touching the first hand at the location on the first hand with the digit of the second hand; and
in response to detecting the hand touch event, performing third operations comprising:
rendering of the interactive virtual object using a third set of attributes;
re-displaying the interactive virtual object to the user; and
determining a user interface interaction based on the hand touch event at the location.

17. The machine of claim 16, wherein the third set of attributes include rendering the interactive virtual object as a translucent spheroid having a dimpled upper surface and encircled by a ring.

18. The machine of claim 16, wherein the third set of attributes include rendering the interactive virtual object as an internally lighted translucent spheroid having a dimpled upper surface and encircled by a light emitting ring.

19. The machine of claim 11,
wherein the interactive virtual object comprises one or more icons, and
wherein the operations further comprise:
rendering and displaying the one or more icons oriented to be visible to the user independently of a position of the first hand.

20. A machine-storage medium, the machine-storage medium including instructions that, when executed by a machine, cause the machine to perform operations comprising:
capturing, using one or more sensors of an eXtended Reality (XR) system, tracking data of a first hand and a second hand of a user;
while continuing to capture the tracking data, performing first operations comprising:
generating, using the tracking data, an interactive XR user interface including an interactive virtual object associated with a location on the first hand;
rendering the interactive virtual object using a first set of attributes;
displaying the interactive virtual object as a component of the interactive XR user interface;
detecting, using the tracking data, a hover event of the user holding a digit of the second hand in proximity to the location on the first hand without touching the location; and
in response to detecting the hover event, performing second operations comprising:
rendering of the interactive virtual object using a second set of attributes; and
re-displaying the interactive virtual object as a component of the interactive XR user interface.
